(19) United States
(12) Patent Application Publication
(10) Pub. No.: US 2020/0140733 A1
(43) Pub. Date: May 7, 2020

(54) ABRASIVE PARTICLES

(71) Applicant: 3M INNOVATIVE PROPERTIES COMPANY, St Paul, MN (US)

(72) Inventors: Laura M. Lara Rodriguez, Woodbury, MN (US); Dwight D. Erickson, Woodbury, MN (US); Chainika Jangu, Woodbury, MN (US); Amelia W. Koenig, Minneapolis, MN (US)

(21) Appl. No.: 16/622,010

(22) PCT Filed: Jun. 12, 2018
(86) PCT No.: PCT/US2018/037023

§ 371 Date: Dec. 12, 2019

Related U.S. Application Data
(60) Provisional application No. 62/518,878, filed on Jun. 13, 2017.

(51) Int. Cl. C09K 3/14; C04B 35/117; C04B 35/64

(52) U.S. Cl. CPC C09K 3/1445; C04B 35/117; C04B 35/64; C04B 2235/3217; C04B 2235/606; C04B 2235/3206; C04B 2235/5436; C04B 2235/5445; C04B 2235/3272

(57) ABSTRACT

The formed ceramic abrasive particle includes a plurality of ceramic oxides. The particle further includes a first plurality of oxides, a second plurality of oxides, or a mixture thereof. The first plurality of oxides includes an oxide of yttrium, praseodymium, samarium, ytterbium, neodymium, lanthanum, gadolinium, dysprosium, erbium, or a combination thereof. The second plurality of oxides includes an oxide of iron, magnesium, zinc, silicon, cobalt, nickel, zirconium, hafnium, chromium, cerium, titanium, or a combination thereof. The formed ceramic abrasive particle further includes a plurality of edges, each edge having a length independently ranging from about 0.1 μm to about 5000 μm. The formed ceramic abrasive particle further includes a tip defined by a junction of at least two of the edges, the tip can have a radius of curvature ranging from about 0.5 μm to about 80 μm.

### CROSS-REFERENCE TO RELATED APPLICATION

This application claims the benefit of priority to U.S. Provisional Patent Application Ser. No. 62/518,878 entitled “ABRASIVE PARTICLES,” filed Jun. 13, 2017, the disclosure of which is incorporated herein in its entirety by reference.

### BACKGROUND

Abrasive particles and abrasive articles made from the abrasive particles are useful for abrading, finishing, or grinding a wide variety of materials and surfaces in the manufacturing of goods. As such, there continues to be a need for improving the cost, performance, or life of abrasive particles or abrasive articles.

### SUMMARY OF THE DISCLOSURE

The present disclosure provides a formed ceramic abrasive particle.

The formed ceramic abrasive particle includes a plurality of ceramic oxides. The particle further includes a first plurality of oxides, a second plurality of oxides, or a mixture thereof. The first plurality of oxides includes an oxide of yttrium, praseodymium, samarium, ytterbium, neodymium, lanthanum, gadolinium, dysprosium, erbium, or a combination thereof. The second plurality of oxides includes an oxide of iron, magnesium, zinc, silicon, cobalt, nickel, zirconium, hafnium, chromium, cerium, titanium, or a combination thereof. The formed ceramic abrasive particle further includes a plurality of edges, each edge having a length independently ranging from about 0.1 μm to about 5000 μm. The formed ceramic abrasive particle further includes a tip defined by a junction of at least two of the edges, the tip can have a radius of curvature ranging from about 0.5 μm to about 80 μm.

The present disclosure further provides a method of making a formed ceramic abrasive particle. The formed ceramic abrasive particle includes a plurality of ceramic oxides. The particle further includes a first plurality of oxides, a second plurality of oxides, or a mixture thereof. The first plurality of oxides includes an oxide of yttrium, praseodymium, samarium, ytterbium, neodymium, lanthanum, gadolinium, dysprosium, erbium, or a combination thereof. The second plurality of oxides includes an oxide of iron, magnesium, zinc, silicon, cobalt, nickel, zirconium, hafnium, chromium, cerium, titanium, or a combination thereof. The formed ceramic abrasive particle further includes a plurality of edges, each edge having a length independently ranging from about 0.1 μm to about 5000 μm. The formed ceramic abrasive particle further includes a tip defined by a junction of at least two of the edges, the tip can have a radius of curvature ranging from about 0.5 μm to about 80 μm. The method includes molding a dispserion comprising a ceramic particle or precursor thereof at least one of the first plurality of oxides and the second plurality of oxides. The molded dispersion can be dried to form a solid and calcinated to form a particle.

The present disclosure further provides a coated abrasive article. The coated abrasive article includes a backing defining a surface along an x-y direction. The coated abrasive article includes an abrasive layer comprising a formed ceramic abrasive particle attached to the backing by a make coat. The formed ceramic abrasive particle includes a plurality of ceramic oxides. The particle further includes a first plurality of oxides, a second plurality of oxides, or a mixture thereof. The first plurality of oxides includes an oxide of yttrium, praseodymium, samarium, ytterbium, neodymium, lanthanum, gadolinium, dysprosium, erbium, or a combination thereof. The second plurality of oxides includes an oxide of iron, magnesium, zinc, silicon, cobalt, nickel, zirconium, hafnium, chromium, cerium, titanium, or a combination thereof. The formed ceramic abrasive particle further includes a plurality of edges, each edge having a length independently ranging from about 0.1 μm to about 5000 μm. The formed ceramic abrasive particle further includes a tip defined by a junction of at least two of the edges, the tip can have a radius of curvature ranging from about 0.5 μm to about 80 μm.

The present disclosure further provides a bonded abrasive article. The bonded abrasive article includes a first major surface and an opposed second major surface each contacting a peripheral side surface. A central axis extends through the first and second major surfaces. The bonded abrasive article includes a layer including a formed ceramic abrasive particle. The formed ceramic abrasive particle is dispersed within a binder material. The formed ceramic abrasive particle includes a plurality of ceramic oxides. The particle further includes a first plurality of oxides, a second plurality of oxides, or a mixture thereof. The first plurality of oxides includes an oxide of yttrium, praseodymium, samarium, ytterbium, neodymium, lanthanum, gadolinium, dysprosium, erbium, or a combination thereof. The second plurality of oxides includes an oxide of iron, magnesium, zinc, silicon, cobalt, nickel, zirconium, hafnium, chromium, cerium, titanium, or a combination thereof. The formed ceramic abrasive particle further includes a plurality of edges, each edge having a length independently ranging from about 0.1 μm to about 5000 μm. The formed ceramic abrasive particle further includes a tip defined by a junction of at least two of the edges, the tip can have a radius of curvature ranging from about 0.5 μm to about 80 μm.

The present disclosure further provides a method of using a coated abrasive article or a bonded abrasive article each including a formed ceramic abrasive particle that includes a plurality of ceramic oxides. The formed ceramic abrasive particle includes a plurality of ceramic oxides. The particle further includes a first plurality of oxides, a second plurality of oxides, or a mixture thereof. The first plurality of oxides includes an oxide of yttrium, praseodymium, samarium, ytterbium, neodymium, lanthanum, gadolinium, dysprosium, erbium, or a combination thereof. The second plurality of oxides includes an oxide of iron, magnesium, zinc, silicon, cobalt, nickel, zirconium, hafnium, chromium, cerium, titanium, or a combination thereof. The formed ceramic abrasive particle further includes a plurality of edges, each edge having a length independently ranging from about 0.1 μm to about 5000 μm. The formed ceramic abrasive particle further includes a tip defined by a junction of at least two of the edges, the tip can have a radius of curvature ranging from about 0.5 μm to about 80 μm.

The method includes contacting the coated abrasive article or the bonded abrasive article with a substrate. At least one of the coated abrasive article or bonded abrasive article is moved relative to the substrate or the substrate is moved relative to the coated abrasive article or bonded abrasive article.

The formed ceramic abrasive particles and abrasive articles of the present disclosure provide several benefits, at least some of which are unexpected. For example, according to some embodiments, the radius of curvature of a tip of the particle is maintained during abrasion of a workpiece over a larger number of cycles than a corresponding formed abrasive particle that is free of at least one of the first plurality of oxides and the second plurality of oxides. According to some embodiments, a porosity of the abrasive particles is less than a corresponding formed abrasive particle that is free of at least one of the first plurality of oxides and the second plurality of oxides. According to some embodiments, the lower porosity can produce a tougher formed ceramic abrasive particle. In some embodiments a length of a ceramic oxide is less than that of a ceramic oxide of a corresponding formed abrasive particle that is free of at least one of the first plurality of oxides and the second plurality of oxides.

In some embodiments, a formed ceramic abrasive particle with a size along a major dimension of about 0.01 μm to about 200 μm or less shows less breakdown than a corresponding formed abrasive particle that is free of at least one of the first plurality of oxides and the second plurality of oxides. In some embodiments the first or second plurality of metal oxides alone or in a reaction can slow growth of a ceramic oxide of alpha-alumina during firing. According to some embodiments, this can result in smaller ceramic oxides, which can yield more control over the characteristics of the ceramic oxides during firing. For example, through the use of the metal oxides disclosed herein, the user may not need to precisely control the firing temperature or time at temperature to achieve a certain ceramic oxide size distribution. Additionally, according to some embodiments of the present disclosure, certain metal oxides may provide better electrostatic coating activity and better orientation (e.g., tips upward) on backings.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIGS. 1A-1D are schematic diagrams of formed ceramic abrasive particles having a planar trigonal shape, in accordance with various embodiments.

FIGS. 2A-2E are schematic diagrams of formed ceramic abrasive particles having a tetrahedral shape, in accordance with various embodiments.

FIG. 3 is a sectional view of a coated abrasive article, in accordance with various embodiments.

FIG. 4 is a sectional view of a bonded abrasive article, in accordance with various embodiments.

FIG. 5 is a photograph of abrasive particles SAP1, in accordance with various embodiments.

FIG. 6 is a photograph of abrasive particles SAP8, in accordance with various embodiments.

FIG. 7 is a photograph of abrasive particles SAP9, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading can occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “formed ceramic abrasive particle”, as used herein, refers to an abrasive particle with at least a portion of the abrasive particle having a predetermined shape that is replicated from a mold cavity. Except in the case of abrasive shards, the formed ceramic abrasive particle will generally have a predetermined geometric shape that substantially replicates the mold cavity that was used to form the formed ceramic abrasive particle. “Formed ceramic abrasive particle”, as used herein, excludes abrasive particles obtained by a mechanical crushing operation.

With respect to the three-dimensional shape of the formed ceramic abrasive particle in accordance with the present disclosure, the term “length” shall mean the largest particle dimension. The longest dimension can refer to an edge length or body length for example. The width shall mean the maximum particle dimension perpendicular to the length. The thickness as referred to herein is also typically perpendicular to length and width. The particle size can be a weight average or number average particle size.

The term “thickness”, when applied to a formed ceramic abrasive particle having a thickness that varies over its planar configuration, shall mean the maximum thickness. If the particle is of substantially uniform thickness, the values of minimum, maximum, mean, and median thickness shall be substantially equal. For example, in the case of a triangle, if the thickness is equivalent to “a”, the length of the shortest side of the triangle may be at least “1.5a” or “2a”. In the case of a particle in which two or more of the shortest facial dimensions are of equal length, the foregoing relationship continues to hold. In most cases, the formed ceramic abrasive particles are polygons having at least three sides, the length of each side being greater than the thickness of the particle. In the special situation of a circle, ellipse, or a polygon having very short sides, the diameter of the circle, minimum diameter of the ellipse, or the diameter of the circle that can be circumscribed about the very short-sided polygon is considered to be the shortest facial dimension of the particle.

### Abrasive Particles

For further illustration, in the case of a tetrahedral-formed ceramic abrasive particle, the length would correspond to the side length of one triangle side, the width would be the dimension between the tip of one triangle side and perpendicular to the opposite side edge, and the thickness would correspond to what is normally referred to as “height of a tetrahedron”, that is, the dimension between the tip and perpendicular to the base (or first side).

The formed ceramic abrasive particles of the present disclosure each have a substantially precisely formed three-dimensional shape. The shape of the formed ceramic abrasive particles, for example, is one that substantially replicates the mold cavity that was used to form the formed ceramic abrasive particles.

In some examples, the formed ceramic abrasive particles can be characterized as thin bodies. The term “thin bodies” is used herein in order to distinguish between elongated or filamentary particles (e.g., rods), wherein one particle dimension (length, longest particle dimension) is substantially greater than each of the other two particle dimensions (width and thickness), as opposed to the particle disclosed herein in which the three particle dimensions (length, width, and thickness as defined herein) are either of the same order of magnitude or two particle dimensions (length and width) are substantially greater than the remaining particle dimension (thickness). Conventional filamentary abrasive particles can be characterized by an aspect ratio, that is, the ratio of the length (longest particle dimension) to the greatest cross-sectional dimension (the greatest cross-sectional dimension perpendicular to the length) of from about 1:1 to about 50:1, about 2:1 to about 50:1 or from about 5:1 to about 25:1. Furthermore, such conventional filamentary abrasive particles are characterized by a cross-sectional shape (the shape of a cross section taken perpendicular to the length or longest dimension of the particle) which does not vary along the length. In contrast, formed ceramic abrasive particles according to the present disclosure can be characterized by a cross-sectional shape that varies along the length of the particle. Variations can be based on the size of the cross-sectional shape or on the form of the cross-sectional shape.

The formed abrasive particles generally each include at least a first side and a second side separated by a thickness t. The first side generally includes a first face (which can be a planar or non-planar face) having a perimeter of a first geometric shape. In some examples, the thickness t is equal to or smaller than the length of the shortest side-related dimension of the particle (the shortest dimension of the first side and the second side of the particle; the length of the shortest side-related dimension of the particle can also be referred to herein as the length of the shortest facial dimension of the particle).

In some examples, the second side includes a tip separated from the first side by thickness t, or the second side includes a ridge line separated from the first side by thickness t, or the second side includes a second face separated from the first side by thickness t. For example, the second side can include a tip and at least one sidewall connecting the tip and the perimeter of the first face (illustrative examples include pyramidal shaped particles, for example, tetrahedral-shaped particles). Alternatively, the second side can include a ridge line and at least one sidewall connecting the ridge line and the perimeter of the first face (illustrative examples include roof-shaped particles). Alternatively, the second side can include a second face and at least one sidewall (which can be a sloping sidewall) connecting the second face and the first face (illustrative examples include triangular prisms or truncated pyramids).

The thickness t can be the same (for example, in embodiments wherein the first and second sides include parallel planar faces) or vary over the planar configuration of the particle (for example, in embodiments wherein one or both of the first and second sides include non-planar faces or in embodiments wherein the second side includes a tip or a ridge line as discussed in more detail later herein). The dimension of the thickness of the particles is not particularly limited. For example, the thickness can be about 5 μm to about 4 mm, 10 μm to about 3 mm, about 25 μm to about 1600 μm, about 30 μm to about 1200 μm, or about 200 μm to about 500 μm.

In some examples, the ratio of the length of the shortest side-related dimension of the formed ceramic abrasive particle to the thickness of the formed ceramic abrasive particle can range from about 1:1 to about 10:1, about 2:1 to about 8:1, about 3:1 to about 6:1, or less than, equal to, or greater than about 1:1, 2:1, 3:1, 4:1, 5:1, 6:1, 7:1, 8:1, 9:1, or 10:1. This ratio can also be referred to as the primary aspect ratio.

The formed ceramic abrasive particles can be selected to have a length (e.g., an edge length) in a range of from 0.1 μm to 5000 μm, about 1 μm to about 200 μm, or about 150 μm to about 180 μm, or can be less than, equal to, or greater than about 0.1 μm, 0.5 1, 5, 10, 15, 20, 25, 30, 35, 40, 45, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000, 4050, 4100, 4150, 4200, 4250, 4300, 4350, 4400, 4450, 4500, 4550, 4600, 4650, 4700, 4750, 4800, 4850, 4900, 4950, or 5000 μm. In some embodiments, the length can be expressed as a fraction of the thickness of the bonded abrasive article in which it is contained. For example, the formed ceramic abrasive particle can have a length greater than half the thickness of the bonded abrasive wheel. In some embodiments, the length can be greater than the thickness of the bonded abrasive wheel. The formed ceramic abrasive particles are selected to have a width in a range of from 0.001 mm to 26 mm, 0.1 mm to 10 mm, or 0.5 mm to 5 mm, although other dimensions can also be used.

The formed ceramic abrasive particles can have various volumetric aspect ratios. The volumetric aspect ratio is defined as the ratio of the maximum cross sectional area passing through the centroid of a volume divided by the minimum cross sectional area passing through the centroid. In various examples of the disclosure, the volumetric aspect ratio for the formed ceramic abrasive particles can be in a range from about 1.15 to about 10.0, about 1.20 to about 5.0, about 1.30 to about 3.0, or less than, equal to, or greater than about 1.15, 1.20, 1.30, 2, 2.5, 3, 3.5, 4, 4.5, 5, 5.5, 6, 6.5, 7, 7.5, 8, 8.5, 9, 9.5, or 10.

For some shapes, the maximum or minimum cross sectional area can be a plane tipped, angled, or tilted with respect to the external geometry of the shape. For example, a sphere would have a volumetric aspect ratio of 1.000 while a cube will have a volumetric aspect ratio of 1.414. A formed ceramic abrasive particle in the form of an equilateral triangle having each side equal to length A and a uniform thickness equal to A will have a volumetric aspect ratio of 1.54, and if the uniform thickness is reduced to 0.25 A, the volumetric aspect ratio is increased to 2.64.

The abrasive particles can be in the shape of thin three-dimensional bodies having various three-dimensional shapes. Suitable examples include particles (e.g., thin bodies) in the form of flat triangles and flat rectangles which have at least one face or two faces that is/are shaped inwardly (for example, recessed or concave).

The first side generally includes a first face having a perimeter of a first geometric shape. For example, the first geometric shape can be selected from geometric shapes having at least one tip, two or more, or three or more, most or three or four tips. Suitable examples for geometric shapes having at least one tip include polygons (including equilateral, equiangular, star-shaped, regular and irregular polygons), lens-shapes, lune-shapes, circular shapes, semicircular shapes, oval shapes, circular sectors, circular segments, drop-shapes and hypocycloids (for example, super elliptical shapes). Specific examples for suitable polygonal geometric shapes include triangular shapes and quadrilateral shapes (for example, a square, a rectangle, a rhombus, a rhomboid, a trapezoid, a kite, or a superellipse).

The tips of suitable quadrilateral shapes can be further classified as a pair of opposing major tips that are intersected by a longitudinal axis and a pair of opposing minor tips located on opposite sides of the longitudinal axis. Formed ceramic abrasive particles having a first side having this type of quadrilateral shape can be characterized by an aspect ratio of a maximum length along a longitudinal axis divided by the maximum width transverse to the longitudinal axis of about 1.3 to about 5, about 2 to about 4, or less than, equal to, or greater than about 1.3, 1.5, 2, 2.5, 3, 3.5, 4, 4.5, or 5. This aspect ratio is also referred to herein as secondary aspect ratio.

In some examples, the first geometric shape is selected from triangular shapes, such as an isosceles triangular shape such as an equilateral triangular shape, a right triangular shape, a scalene triangle shape, an acute triangle shape, or an obtuse triangle shape. In other examples, the first geometric shape is selected from quadrilateral shapes, such as a square, a rectangle, a rhombus, a rhomboid, a trapezoid, a kite, or a superellipse, or from the group of a rectangle, a rhombus, a rhomboid, a kite or a superellipse.

For the purposes of this disclosure, geometric shapes are also intended to include regular or irregular polygons or stars wherein one or more edges (parts of the perimeter of the face) can be arcuate (either towards the inside or towards the outside). Hence, for the purposes of this disclosure, triangular shapes also include three-sided polygons wherein one or more of the edges (parts of the perimeter of the face) can be arcuate, e.g., the definition of triangular extends to spherical triangles and the definition of quadrilaterals extends to superellipses.

The second side can include a second face. The second face can have a perimeter of a second geometric shape. The second geometric shape can be the same as or different from the first geometric shape. In some examples the second geometric shape is selected to have substantially the same shape as the first geometric shape and is arranged in a congruent way with the first geometric shape (although the size or area of the geometric shapes can be different, e.g., the one face can be larger than the other one).

As used herein with respect to the case of a substantially identical first and second geometric shapes, the term “arranged in a congruent way with the first geometric shape” is intended to include the case wherein the first and the second geometric shapes are slightly rotated against each other. The degree (or angle of rotation) depends on the particular geometric shape of the first face and of the second face and the thickness of the particle. Acceptable angles of rotation can range from 0 to +/−30 degrees, from 0 to +/−15 degrees, from 0 to +/−10 degrees, or about 0 degrees (for example, from 0 to +/−5 degrees).

Examples of suitable geometric shapes of the perimeter of the second face include shapes described herein with respect to the first geometric shapes.

In some examples, the first and also the second geometric shape is selected from triangular shapes, such as an isosceles triangular shape or an equilateral triangular shape.

The first face can be substantially planar or the second face (if present) can be substantially planar. Also, both faces can be substantially planar. In some cases, the first face is planar (and identical to the first side). Alternatively, at least one of the first and the second face (if present) can be a non-planar face. Also both faces can be non-planar faces. For example, one or both of the first and the second face (if present) can be shaped inwardly (for example, recessed or concave) or can be shaped outwardly (for example, convex).

For example, the first face (or the second face, if present) can be shaped inwardly (for example, recessed or concave) and the second face (if present, or the first face) can be substantially planar. Alternatively, the first face (or the second face, if present) can be shaped outwardly (for example, convex) and the second face (if present, or the first face) can be shaped inwardly (for example, recessed or concave), or, the first face can be shaped inwardly (for example, recessed or concave) and the second face (if present) can also be shaped inwardly (for example, recessed or concave).

The first face and the second face (if present) can be substantially parallel to each other. Alternatively, the first face and the second face (if present) can be nonparallel, for example, such that imaginary lines tangent to each face would intersect at a point (as in the exemplary case wherein one face is sloped with respect to the other face).

The second face can be connected to the perimeter of the first face by at least one sidewall which can be a sloping sidewall. The sidewall can include one or more facets, which can be selected from quadrilateral facets. Specific examples of shaped particles having a second face include prisms (for example, triangular prisms) and truncated pyramids.

In some examples, the second side includes a second face and four facets that form a sidewall (draft angle alpha between the sidewall and the second face equals 90 degrees) or a sloping sidewall (draft angle alpha between the sidewall and the second face is greater than 90 degrees). As the thickness, t, of the formed ceramic abrasive particle having a sloping sidewall becomes greater, the formed ceramic abrasive particle resembles a truncated pyramid when the draft angle alpha is greater than 90 degrees.

The formed ceramic abrasive particles can include at least one sidewall, which can be a sloping sidewall. The first face and the second face can be connected to each other by the at least one sidewall. In other examples, the ridge line and the first face are connected to each other by the at least one sidewall. In other examples, the tip and the first face are connected to each other by the at least one sidewall.

In some examples, more than one (for example, two or three) sloping sidewalls can be present and the slope or angle for each sloping sidewall can be the same or different. In some embodiments, the first face and the second face are connected to each other by a sidewall. In other embodiments, the sidewall can be minimized for particles where the faces taper to a thin edge or point where they meet instead of having a sidewall.

The sidewall can vary and it generally forms the perimeter of the first face and the second face (if present). In the case of a sloping sidewall, it forms a perimeter of the first face and a perimeter of the second face (if present). In one example, the perimeter of the first face and the second face is selected to be a geometric shape, and the first face and the second face are selected to have the same geometric shape, although they can differ in size with one face being larger than the other face.

A draft angle alpha between the second face and the sloping sidewall of the formed ceramic abrasive particle can be varied to change the relative sizes of each face. In various embodiments of the disclosure, the area or size of the first face and the area or size of the second face are substantially equal. In other embodiments of the disclosure, the first face or second face can be smaller than the other face.

In one example of the disclosure, draft angle alpha can be approximately 90 degrees such that the area of both faces are substantially equal. In another embodiment of the disclosure, draft angle alpha can be greater than 90 degrees such that the area of the first face is greater than the area of the second face. In another embodiment of the disclosure, draft angle alpha can be less than 90 degrees such that the area of the first face is less than the area of the second face. In various examples of the disclosure, the draft angle alpha can be from about 95 degrees to about 130 degrees, about 95 degrees to about 125 degrees, about 95 degrees to about 120 degrees, about 95 degrees to about 115 degrees, about 95 degrees to about 110 degrees, about 95 degrees to about 105 degrees, or about 95 degrees to about 100 degrees.

The first face and the second face can also be connected to each other by at least a first sloping sidewall having a first draft angle and by a second sloping sidewall having a second draft angle, which is selected to be a different value from the first draft angle. In addition, the first and second faces can also be connected by a third sloping sidewall having a third draft angle, which is a different value from either of the other two draft angles. In one embodiment, the first, second, and third draft angles are all different values from each other. For example, the first draft angle can be 120 degrees, the second draft angle can be 110 degrees, and the third draft angle can be 100 degrees.

Similar to the case of an abrasive particle having one sloping sidewall, the first, second, and third sloping sidewalls of the formed ceramic abrasive particle with a sloping sidewall can vary and can generally from the perimeter of the first face and the second face.

In general, the first, second, and third draft angles between the second face and the respective sloping sidewall of the formed ceramic abrasive particle can be varied with at least two of the draft angles being different values, and desirably all three being different values. In various embodiments of the disclosure, the first draft angle, the second draft angle, and the third draft angle can be between about 95 degrees to about 130 degrees, or between about 95 degrees to about 125 degrees, or between about 95 degrees to about 120 degrees, or between about 95 degrees to about 115 degrees, or between about 95 degrees to about 110 degrees, or between about 95 degrees to about 105 degrees, or between about 95 degrees to about 100 degrees.

Additionally, the various sloping sidewalls of the formed ceramic abrasive particles can have the same draft angle or different draft angles. Furthermore, a draft angle of 90 degrees can be used on one or more sidewalls. However, if a formed ceramic abrasive particle with a sloping sidewall is desired, at least one of the sidewalls is a sloping sidewall having a draft angle of greater than about 90 degrees, or 95 degrees or greater.

The sidewall can be precisely shaped and can be, for example, either concave or convex. Alternatively, the sidewall (top surface) can be uniformly planar. By “uniformly planar” it is meant that the sidewall is free of areas that are convex from one face to the other face, or areas that are concave from one face to the other face. For example, at least 50%, or at least 75%, or at least 85% or more of the sidewall surface can be planar. The uniformly planar sidewall provides better defined (e.g., sharper) edges where the sidewall intersects with the first face and the second face, and this is also thought to enhance grinding performance. The sidewall can also include one or more facets, which can be selected from triangular and quadrilateral facets or a combination of triangular and quadrilateral facets. The angle beta between the first side and the sidewall can be between 20 degrees to about 50 degrees, or between about 10 degrees to about 60 degrees, or between about 5 degrees to about 65 degrees.

The second side can include a ridge line. The ridge line can be connected to the perimeter of the first face by at least one sidewall, which can be a sloping sidewall, as discussed herein. The sidewall can include one or more facets, which can be selected from triangular and quadrilateral facets or a combination of triangular and quadrilateral facets.

The ridge line can be substantially parallel to the first side. Alternatively, the ridge line can be non-parallel to the first side, for example, such that an imaginary line tangent to the ridge line would intersect the first side at a point (as in the exemplary case wherein the ridge line is sloped with respect to the first face). The ridge line can be straight lined or can be non-straight lined, as in the case wherein the ridge line includes arcuate structures.

The facets can be planar or non-planar. For example, at least one of the facets can be non-planar, such as concave or convex. In some embodiments, all of the facets can be non-planar facets, for example, concave facets.

In some embodiments, the first geometric shape is selected from a quadrilateral having four edges and four tips (for example, from the group including a rhombus, a rhomboid, a kite, or a superellipse) and the second side can include a ridge line and four facets forming a structure similar to a hip roof Thus, two opposing facets will have a triangular shape and two opposing facets will have a trapezoidal shape.

The second side can include a tip and at least one sidewall connecting the tip and the perimeter of the first face. The at least one sidewall can be a sloping sidewall, as discussed in the foregoing. The sidewall can include one or more facets, which can be selected from triangular facets. The facets can be planar or non-planar. For example, at least one of the facets can be non-planar, such as concave or convex. In some embodiments, all of the facets can be non-planar facets, for example, concave facets.

In some examples the second side includes a tip and a sidewall and can include triangular facets forming a pyramid. The number of facets included by the sidewall will depend on the number of edges present in the first geometric shape (defining the perimeter of the first face). For example, pyramidal formed ceramic abrasive particles having a first side characterized by a trilateral first geometric shape will generally have three triangular facets meeting in the tip thereby forming a pyramid, and pyramidal formed ceramic abrasive particles having a first side characterized by a quadrilateral first geometric shape will generally have four triangular facets meeting in the tip thereby forming a pyramid, and so on.

In some examples, the second side includes a tip and four facets forming a pyramid. In some examples, the first side of the formed ceramic abrasive particle includes a quadrilateral first face having four edges and four tips with the quadrilateral or being selected from the group of a rhombus, a rhomboid, a kite, or a superellipse. The shape of the perimeter of the first face (e.g., the first geometric shape) can be selected from the above groups since these shapes will result in a formed ceramic abrasive particle with opposing major tips along the longitudinal axis and in a shape that tapers from the transverse axis toward each opposing major tip.

The degree of taper can be controlled by selecting a specific aspect ratio for the particle as defined by the maximum length, L, along the longitudinal axis divided by the maximum width, W, along the transverse axis that is perpendicular to the longitudinal axis. This aspect ratio (also referred to herein as “secondary aspect ratio”) should be greater than 1.0 for the formed ceramic abrasive particle to taper as can be desirable in some applications. In various embodiments of the disclosure, the secondary aspect ratio is between about 1.3 to about 10, or between about 1.5 to about 8, or between about 1.7 to about 5. As the secondary aspect ratio becomes too large, the formed ceramic abrasive particle can become too fragile.

The formed ceramic abrasive particles can have a perimeter of the first and optionally of the second face that includes one or more corner points having a sharp tip. In some examples, all of the corner points included by the perimeter(s) have sharp tips. The formed ceramic abrasive particles can also have sharp tips along any edges that can be present in a sidewall (for example, between two meeting facets included by a sidewall).

The sharpness of a corner point can be characterized by the radius of curvature along the corner point, wherein the radius extends to the interior side of the perimeter. In various embodiments of the disclosure, the radius of curvature (also referred to herein as average tip radius) can range from about 0.5 μm to about 80 μm, about 0.5 μm to about 60 μm, about 0.5 μm to about 20 μm, or about 1 μm to about 10 μm, or can be less than, equal to, or greater than about 0.5 μm, 1, 5, 10, 15, 20, 25, 30, 35, 40, 45, 50, 55, 60, 65, 70, 75, or 80 μm. Without intending to be bound to any theory, it is believed that a sharper edge promotes more aggressive cutting and improved fracturing of the formed ceramic abrasive particles during use.

A smaller radius of curvature means that the particle more perfectly replicates the edge or corner features of the mold used to prepare the particle (e.g., of the ideal shape of the particle), thus the formed ceramic abrasive particles are much more precisely made. In some examples, shaped abrasive articles (in particular, formed ceramic abrasive particles) can be made by using a mold of the desired shape, which provides more precisely made particles than methods based on other methods for preparing formed ceramic abrasive particles, such as methods based on pressing, punching, or extruding.

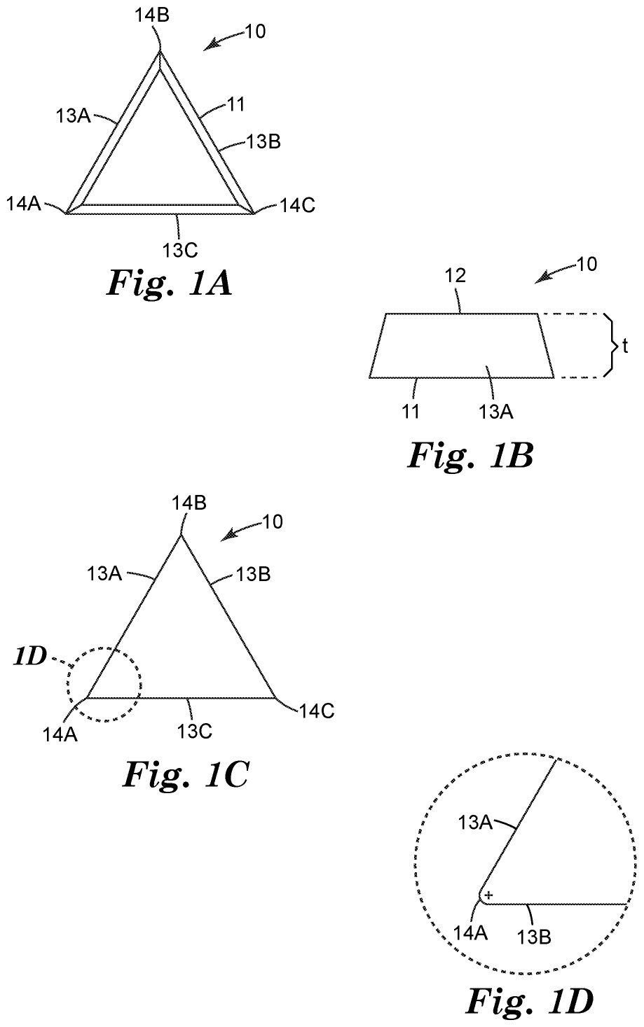

As an example of formed ceramic abrasive particles having a planar trigonal shape, FIGS. 1A-1B show trigonal formed ceramic abrasive particle 10 is bounded by a trigonal base 11, a trigonal top 12, and plurality of sidewalls 13A, 13B, 13C connecting base 11 and top 12. Base 11 has tips 14A, 14B, 14C having an average radius of curvature of less than 50 micrometers. FIGS. 1C-1D show one face of formed ceramic abrasive particles 10 to better show radius of curvature for tip 14A. In general, the smaller the radius of curvature, the sharper the sidewall edge will be. In some cases, the base and the top of the formed ceramic abrasive particles are substantially parallel, resulting in prismatic or truncated pyramidal (as shown in FIGS. 1A-1B) shapes, although this is not a requirement. As shown, sidewalls 13A, 13B, 13C have equal dimensions and form dihedral angles with base 11 of about 82 degrees. However, it will be recognized that other dihedral angles (including 90 degrees) can also be used. For example, the dihedral angle between the base and each of the sidewalls can independently range from 45 to 90 degrees, 70 to 90 degrees, or 75 to 85 degrees.

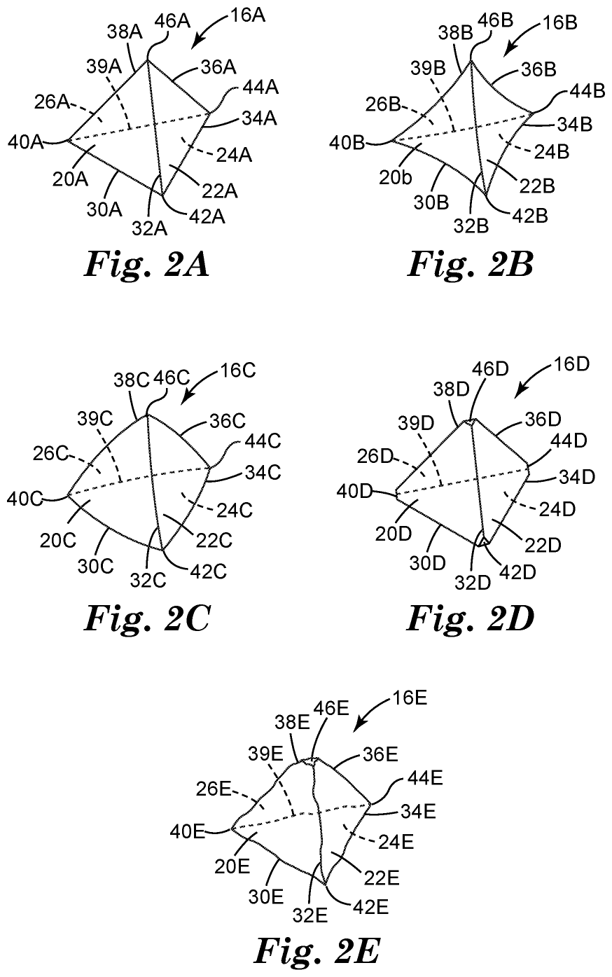

FIGS. 2A-2E show examples of formed ceramic abrasive particles 16 having a tetrahedral shape. As shown in FIGS. 2A-2E, the tetrahedral abrasive particles 16 are shaped as regular tetrahedrons. As shown in FIG. 2A, a tetrahedral abrasive particle 16A has four faces (20A, 22A, 24A, and 26A) joined by six edges (30A, 32A, 34A, 36A, 38A, and 39A) terminating at four tips (40A, 42A, 44A, and 46A). Each of the faces contacts the other three faces at the edges. While a regular tetrahedron (e.g., having six equal edges and four faces) is depicted in FIG. 2A, it will be recognized that other shapes are also permissible. For example, the tetrahedral abrasive particles 16A can be shaped as irregular (e.g., having edges of differing lengths) tetrahedrons.

Referring now to FIG. 2B, a tetrahedral abrasive particle 16B has four faces (20B, 22B, 24B, and 26B) joined by six edges (30B, 32B, 34B, 36B, 38B, and 39B) terminating at four tips (40B, 42B, 44B, and 46B). Each of the faces is concave and contacts the other three faces at respective common edges. While a particle with tetrahedral symmetry (e.g., four rotational axes of threefold symmetry and six reflective planes of symmetry) is depicted in FIG. 2B, it will be recognized that other shapes are also permissible. For example, the tetrahedral abrasive particles 16B can have one, two, or three concave faces with the remainder being planar.

Referring now to FIG. 2C, a tetrahedral abrasive particle 16C has four faces (20C, 22C, 24C, and 26C) joined by six edges (30C, 32C, 34C, 36C, 38C, and 39C) terminating at four tips (40C, 42C, 44C, and 46C). Each of the faces is convex and contacts the other three faces at respective common edges. While a particle with tetrahedral symmetry is depicted in FIG. 2C, it will be recognized that other shapes are also permissible. For example, the tetrahedral abrasive particles 16C can have one, two, or three convex faces with the remainder being planar or concave.

Referring now to FIG. 2D, a tetrahedral abrasive particle 16D has four faces (20D, 22D, 24D, and 26D) joined by six edges (30D, 32D, 34D, 36D, 38D, and 39D) terminating at four tips (40D, 42D, 44D, and 46D). While a particle with tetrahedral symmetry is depicted in FIG. 2D, it will be recognized that other shapes are also permissible. For example, the tetrahedral abrasive particles 16D can have one, two, or three convex faces with the remainder being planar.

Deviations from the depictions in FIGS. 2A-2D can be present. An example of such a tetrahedral abrasive particle 16E is depicted in FIG. 2E, showing a tetrahedral abrasive particle 10E that has four faces (20E, 22E, 24E, and 26E) joined by six edges (30E, 32E, 34E, 36E, 38E, and 39E) terminating at four tips (40E, 42E, 44E, and 46E). Each of the faces contacts the other three faces at respective common edges. Each of the faces, edges, and tips has an irregular shape.

The formed ceramic abrasive particles (e.g. 10 or 16A-16E) can include any suitable one or more components. Examples of suitable components include ceramic oxides and optional first and second pluralities of oxides. Ceramic oxides can include those comprising an aluminum oxide material such as fused aluminium oxide material, heat treated aluminium oxide material, sintered aluminium oxide material, silicon carbide material, titanium diboride, boron carbide, tungsten carbide, titanium carbide, cubic boron nitride, garnet, fused alumina-zirconia, cerium oxide, zirconium oxide, titanium oxide, or mixtures thereof. The first plurality of oxides can include oxides of rare earth metals. Examples include oxides chosen from an oxide of yttrium, praseodymium, samarium, ytterbium, neodymium, lanthanum, gadolinium, dysprosium, erbium, and mixtures thereof. The second plurality of oxides can include oxides of metals such as alkaline earth metals or other suitable metals. For example, the second plurality of oxides can include oxides chosen from an oxide of iron, magnesium, zinc, silicon, cobalt, nickel, zirconium, hafnium, chromium, cerium, titanium, and mixtures thereof. In the formed ceramic abrasive particle, at least one of the ceramic oxides, the first plurality of oxides, and the second plurality of oxides can be homogenously distributed throughout the abrasive particle.

The ceramic oxides can range from about 5 wt % to about 99 wt % of the formed ceramic abrasive particle, about 20 wt % to about 80 wt %, about 95 wt % to about 99 wt %, or less than, equal to, or greater than 5 wt %, 10, 15, 20, 25, 30, 35, 40, 45, 50, 55, 60, 65, 70, 75, 80, 85, 90, 95, or 99 wt %. The first plurality of metal oxides can range from about 0.01 wt % to about 70 wt % of the abrasive particle, about 2 wt % to about 20 wt %, or less than, equal to, or greater than about 0.1 wt %, 0.5, 1, 5, 10, 15, 20, 25, 30, 35, 40, 45, 50, 55, 60, 65, 70, 75, 80, 85, 90, 95, or 99 wt %. The second plurality of metal oxides similarly can range from about 0.01 wt % to about 70 wt % of the abrasive particle, about 2 wt % to about 20 wt %, about 7 wt % to about 15 wt %, or less than, equal to, or greater than about 0.1 wt %, 0.5, 1, 5, 10, 15, 20, 25, 30, 35, 40, 45, 50, 55, 60, 65, 70, 75, 80, 85, 90, 95, or 99 wt %.

In some examples of the formed ceramic abrasive particle, the particle can include a mixture of ceramic oxides, oxides of iron and oxides of magnesium. In other examples of the formed ceramic abrasive particle, the particle can include a mixture of ceramic oxides, oxides of a rare earth metal, and oxides of magnesium. In other examples of the formed ceramic abrasive particle, the particle can include a mixture of ceramic oxides, oxides of a rare earth metal, and oxides of iron.

In examples of the formed ceramic abrasive particle including an oxide of magnesium, the oxide can be MgO. The MgO can range from about 0.1 wt % to about 10 wt % of the abrasive particle, about 0.7 wt % to about 2 wt %, or less than, equal to, or greater than about 0.1 wt %, 0.5, 0.7, 1, 1.5, 1.7, 2, 2.5, 2.7, 3, 3.5, 3.7, 4, 4.5, 4.7, 5, 5.5, 5.7, 6, 6.5, 6.7, 7, 7.5, 7.7, 8, 8.5, 8.7, 9, 9.5, 9.7, or 10.

The second plurality of metal oxides can include an oxide of iron. As non-limiting examples, the oxide of iron can be chosen from FeO, Fe₂O₃, Fe₃O₄, or mixtures thereof. In some examples the oxide of iron is Fe₂O₃ exclusively. If present, the oxide of iron can range from about 0.1 wt % to about 10 wt % of the abrasive particle, about 0.5 wt % to about 8 wt %, about 1 wt % to about 2 wt %, or less than, equal to, or greater than 0.1 wt %, 0.5, 1, 1.5, 2, 2.5. 3, 3.5, 4, 4.5, 5, 5.5, 6, 6.5, 7, 7.5, 8, 8.5, 9, 9.5, or 10 wt %.

In some examples of the formed ceramic abrasive particle, the second plurality of metal oxides includes a mixture of MgO and Fe₂O₃. The relative amounts of MgO and Fe₂O₃ can vary with respect to each other. In some examples, the formed ceramic abrasive particle can include more MgO relative to Fe₂O₃. In other examples, the formed ceramic abrasive particle can include more Fe₂O₃ relative to MgO.

In some examples of the formed ceramic abrasive particle including an aluminum oxide grain and MgO, magnesium and aluminum can exist as a spindle comprising aluminum and magnesium. A porosity of the formed ceramic abrasive particle can range from about 0.01% to about 5%, about 0.5% to about 2%, or less than, equal to, or greater than about 0.01%, 0.5, 1, 1.5, 2, 2.5, 3, 3.5, 4, 4.5, or 5%. In some examples, a number average size (the largest dimension of the particle, e.g., length) of the individual ceramic oxides can independently range from about 0.05 μm to about 1 μm, about 0.5 μm to about 0.8 μm, or less than, equal to, or greater than about 0.05 μm, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or 1 μm.

### Abrasive Articles

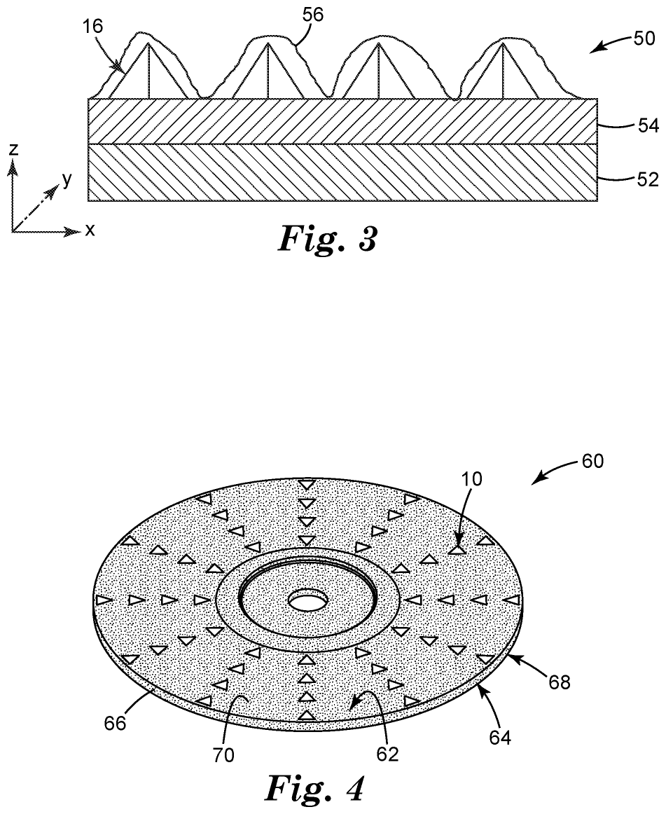

The formed ceramic abrasive particles can be included in many different types of abrasive articles, such as in a coated or bonded abrasive article. FIG. 3 is a sectional view of coated abrasive article 50. Coated abrasive article 50 includes backing 52 defining a surface along an x-y direction. Backing 52 has a first layer of binder, hereinafter referred to as make coat 54, applied over the first surface of backing 52. Attached or partially embedded in make coat 54 are a plurality the formed ceramic abrasive particles 16. In other examples, formed ceramic abrasive particles 10 can be included. A second layer of binder, hereinafter referred to as size coat 56, is dispersed over ceramic abrasive particles 16.

Backing 52 can be flexible or rigid. Examples of suitable materials for forming a flexible backing include a polymeric film, a metal foil, a woven fabric, a knitted fabric, paper, vulcanized fiber, a staple fiber, a continuous fiber, a nonwoven, a foam, a screen, a laminate, and combinations thereof. Backing 52 can be shaped to allow coated abrasive article 50 to be in the form of sheets, discs, belts, pads, or rolls. In some embodiments, backing 52 can be sufficiently flexible to allow coated abrasive article 50 to be formed into a loop to make an abrasive belt that can be run on suitable grinding equipment.

Make coat 54 secures abrasive particles 16 to backing 52, and size coat 56 can help to reinforce tetrahedral abrasive particles 10. Make coat 54 and/or size coat 56 can include a resinous adhesive. The resinous adhesive can include one or more resins chosen from a phenolic resin, an epoxy resin, a urea-formaldehyde resin, an acrylate resin, an aminoplast resin, a melamine resin, an acrylated epoxy resin, a urethane resin, and mixtures thereof.

FIG. 4 is a perspective view of bonded abrasive article 60 including formed ceramic abrasive particles 10. In other examples bonded abrasive article 60 can include formed ceramic abrasive particles 16A-16E. As shown in FIG. 4, bonded abrasive article 60 includes first major surface 62 and opposed second major surface 64 each contacting peripheral side surface 66. A central axis extends through the first and second major surfaces 62 and 64.

Bonded abrasive article 60 includes abrasive layer 68 that includes formed ceramic abrasive particles 10. Formed ceramic abrasive particles 16 are retained in binder 70. Formed ceramic abrasive particles 16 can be wholly or partially retained in the binder and can be arranged in a specified pattern as shown or distributed randomly. The binder can be any suitable binder material. Suitable examples of binder materials include an organic binding material, a vitrified binding material, a metallic binding material, or mixtures thereof.

Coated abrasive article 50 or bonded abrasive article 60 can be shaped to be any suitable tool. Examples of suitable tools include a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a double disk grinding wheel, a belt, or a portion thereof.

Formed ceramic abrasive particles 10 can range from about 1 wt % to about 70 wt % of the coated abrasive article or the bonded abrasive article, about 8 wt % to about 30 wt %, or less than, equal to, or greater than about 1 wt %, 2, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, or 70 wt %.

Either of the coated abrasive article or the bonded abrasive article can include additional abrasive particles beyond the formed ceramic abrasive particles described herein. Examples of additional abrasive particles include crushed abrasive particles. If present, the crushed abrasive particles can range from about 5 wt % to about 96 wt % of the abrasive layer, or about 15 wt % to about 50 wt %, or can be less than, equal to, or greater than about 5 wt %, 10, 15, 20, 25, 30, 35, 40, 45, 50, 55, 60, 65, 70, 75, 80, 85, 90, or 96 wt %. Examples of suitable crushed abrasive particles include, for example, crushed particles of fused aluminum oxide, heat-treated aluminum oxide, white fused aluminum oxide, ceramic aluminum oxide materials such as those commercially available under the trade designation 3M CERAMIC ABRASIVE GRAIN from 3M Company of St. Paul, Minn., black silicon carbide, green silicon carbide, titanium diboride, boron carbide, tungsten carbide, titanium carbide, diamond, cubic boron nitride, garnet, fused alumina zirconia, sol-gel derived abrasive particles, iron oxide, chromia, ceria, zirconia, titania, silicates, tin oxide, silica (such as quartz, glass beads, glass bubbles, and glass fibers), silicates (such as talc, clays (e.g., montmorillonite), feldspar, mica, calcium silicate, calcium metasilicate, sodium aluminosilicate, and sodium silicate), flint, and emery.

The abrasive layer can further include additives, such as, for example, fillers, grinding aids, wetting agents, surfactants, dyes, pigments, coupling agents, adhesion promoters, and combinations thereof. Examples of fillers include calcium carbonate, silica, talc, clay, calcium metasilicate, dolomite, aluminum sulfate, and combinations thereof. Suitable examples of grinding aids include particulate materials that have an effect on the chemical and physical processes of abrading, thereby resulting in improved performance. Grinding aids encompass a wide variety of different materials and can be inorganic or organic. Examples of chemical groups of grinding aids include waxes, organic halide compounds, halide salts, and metals and their alloys. The organic halide compounds can break down during abrading and release a halogen acid or a gaseous halide compound. Examples of such materials include chlorinated waxes, such as tetrachloronaphthalene and pentachloronaphthalene; and polyvinyl chloride. Examples of halide salts include sodium chloride, potassium cryolite, sodium cryolite, ammonium cryolite, potassium tetrafluoroborate, sodium tetrafluoroborate, silicon fluorides, potassium chloride, and magnesium chloride. Examples of metals include tin, lead, bismuth, cobalt, antimony, cadmium, iron, and titanium. Other grinding aids include sulfur, organic sulfur compounds, graphite, and metallic sulfides. It is also within the scope of this disclosure to use a combination of different grinding aids; in some instances, this can produce a synergistic effect. In one embodiment, the grinding aid is cryolite or potassium tetrafluoroborate. The amount of such additives can be adjusted to give desired properties. If present, the additives can range from about 5 wt % to about 95 wt % of the abrasive layer, or about 20 wt % to about 70 wt % of the abrasive layer, or can be less than, equal to, or greater than 5 wt %, 10, 15, 20, 25, 30, 35, 40, 45, 50, 55, 60, 65, 70, 75, 80, 85, 90, or 95 wt %.

### Method of Using Abrasive Articles

A method of using coated abrasive article 50 or the bonded abrasive article 60 can include contacting coated abrasive article 50 or bonded abrasive article 60 with a substrate. The method can further include laterally or rotationally moving at least one of coated abrasive article 50 or bonded abrasive article 60 relative to the substrate and the substrate relative to coated abrasive article 50 or bonded abrasive article 60. The substrate can be many different types of substrates. Non-limiting examples of suitable substrates include paint, primer, stone, a plastic, or combinations thereof.

### Method of Forming Abrasive Particles

In some examples, the formed ceramic abrasive particles (e.g. 10 of 16A-16E) can be made according to a multi-operation process. The process can be carried out using any ceramic precursor dispersion material. Briefly, the process can include the operations of making either a seeded or non-seeded ceramic precursor dispersion that can be converted into a corresponding ceramic (e.g., a boehmite sol-gel that can be converted to alpha alumina), the precursor can also be a non-colloidal slurry dispersion of ceramic particles; filling one or more mold cavities having the desired outer shape of the formed ceramic abrasive particle with a ceramic precursor dispersion; drying the ceramic precursor dispersion to form precursor formed ceramic abrasive particles; removing the precursor formed ceramic abrasive particles from the mold cavities; calcining the precursor formed ceramic abrasive particles to form calcined, precursor formed ceramic abrasive particles; and then sintering the calcined, precursor formed ceramic abrasive particles to form formed ceramic abrasive particles. The process will now be described in greater detail in the context of alpha-alumina-containing formed ceramic abrasive particles.

The process can include the operation of providing either a seeded or non-seeded dispersion of a ceramic precursor that can be converted into ceramic. In examples where the ceramic precursor is seeded, the precursor can be seeded with an oxide of an iron (e.g., Fe₂O₃). The ceramic precursor dispersion can include a liquid that is a volatile component. In one example, the volatile component is water. The dispersion can include a sufficient amount of liquid for the viscosity of the dispersion to be sufficiently low to allow filling mold cavities and replicating the mold surfaces, but not so much liquid as to cause subsequent removal of the liquid from the mold cavity to be prohibitively expensive. In one example, the ceramic precursor dispersion includes from 2 percent to 90 percent by weight of the particles that can be converted into ceramic, such as particles of aluminum oxide monohydrate (boehmite), and at least 10 percent by weight, or from 50 percent to 70 percent, or 50 percent to 60 percent, by weight, of the volatile component such as water. Conversely, the ceramic precursor dispersion in some embodiments contains from 30 percent to 50 percent, or 40 percent to 50 percent solids by weight.

Examples of suitable ceramic precursor dispersions include zirconium oxide sols, vanadium oxide sols, cerium oxide sols, aluminum oxide sols, and combinations thereof. Suitable aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL” and “DISPAL”, both available from Sasol North America, Inc., or “HIQ-40” available from BASF Corporation. These aluminum oxide monohydrates are relatively pure; that is, they include relatively little, if any, hydrate phases other than monohydrates, and have a high surface area. Additionally, in some embodiments, suitable abrasive particle precursor materials include fine abrasive particles that, upon sintering, form a single abrasive particle. In some embodiments, the abrasive particle precursor materials can include, alone or in addition, fine alpha alumina particles that upon sintering fuse together to form a sintered alpha alumina ceramic body, e.g., as disclosed in U.S. Publ. Pat. Appln. No. 2016/0068729 A1 (Erickson et al.). In some examples, a non-colloidal slurry dispersion may be included.

The physical properties of the resulting formed ceramic abrasive particles can generally depend upon the type of material used in the ceramic precursor dispersion. As used herein, a “gel” is a three-dimensional network of solids dispersed in a liquid.

The ceramic precursor dispersion can contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, such as water-soluble salts. They can include a metal-containing compound and can be a precursor of oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the ceramic precursor dispersion can be varied.

The introduction of a modifying additive or precursor of a modifying additive can cause the ceramic precursor dispersion to gel. The ceramic precursor dispersion can also be induced to gel by application of heat over a period of time to reduce the liquid content in the dispersion through evaporation. The ceramic precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina.

A peptizing agent can be added to the ceramic precursor dispersion to produce a more stable hydrosol or colloidal ceramic precursor dispersion. Suitable peptizing agents are monoprotic acids or acid compounds such as acetic acid, hydrochloric acid, formic acid, and nitric acid. Multiprotic acids can also be used, but they can rapidly gel the ceramic precursor dispersion, making it difficult to handle or to introduce additional components. Some commercial sources of boehmite contain an acid titer (such as absorbed formic or nitric acid) that will assist in forming a stable ceramic precursor dispersion.

The ceramic precursor dispersion can be formed by any suitable process; for example, in the case of a sol-gel alumina precursor, it can be formed by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired.

Oxides of magnesium (e.g., MgO) can be impregnated in the ceramic precursor after it has gelled or after it has been calcined. Impregnating the ceramic precursor with oxides of magnesium can help to limit growth of the ceramic oxides and help to decrease porosity of the formed abrasive particles.

A further operation can include providing a mold having at least one mold cavity, or a plurality of cavities formed in at least one major surface of the mold. In some examples, the mold is formed as a production tool, which can be, for example, a belt, a sheet, a continuous web, a coating roll such as a rotogravure roll, a sleeve mounted on a coating roll, or a die. In one example, the production tool can include polymeric material. Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one example, the entire tooling is made from a polymeric or thermoplastic material. In another example, the surfaces of the tooling in contact with the ceramic precursor dispersion while the ceramic precursor dispersion is drying, such as the surfaces of the plurality of cavities, include polymeric or thermoplastic materials, and other portions of the tooling can be made from other materials. A suitable polymeric coating can be applied to a metal tooling to change its surface tension properties, by way of example.

A polymeric or thermoplastic production tool can be replicated off a metal master tool. The master tool can have the inverse pattern of that desired for the production tool. The master tool can be made in the same manner as the production tool. In one example, the master tool is made out of metal (e.g., nickel) and is diamond-turned. In one example, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that can distort the thermoplastic production tool, limiting its life.

Access to cavities can be from an opening in the top surface or bottom surface of the mold. In some examples, the cavities can extend for the entire thickness of the mold. Alternatively, the cavities can extend only for a portion of the thickness of the mold. In one example, the top surface is substantially parallel to the bottom surface of the mold with the cavities having a substantially uniform depth. At least one side of the mold, the side in which the cavities are formed, can remain exposed to the surrounding atmosphere during the step in which the volatile component is removed.

The cavities have a specified three-dimensional shape to make the formed ceramic abrasive particles. The depth dimension is equal to the perpendicular distance from the top surface to the lowermost point on the bottom surface. The depth of a given cavity can be uniform or can vary along its length and/or width. The cavities of a given mold can be of the same shape or of different shapes.

A further operation involves filling the cavities in the mold with the ceramic precursor dispersion (e.g., by a conventional technique). In some examples, a knife roll coater or vacuum slot die coater can be used. A mold release agent can be used to aid in removing the particles from the mold if desired. Examples of mold release agents include oils such as peanut oil or mineral oil, fish oil, silicones, polytetrafluoroethylene, zinc stearate, and graphite. In general, a mold release agent such as peanut oil, in a liquid, such as water or alcohol, is applied to the surfaces of the production tooling in contact with the ceramic precursor dispersion such that between about 0.1 mg/in² (0.6 mg/cm²) to about 3.0 mg/in² (20 mg/cm²), or between about 0.1 mg/in² (0.6 mg/cm²) to about 5.0 mg/in² (30 mg/cm²), of the mold release agent is present per unit area of the mold when a mold release is desired. In some embodiments, the top surface of the mold is coated with the ceramic precursor dispersion. The ceramic precursor dispersion can be pumped onto the top surface.

In a further operation, a scraper or leveler bar can be used to force the ceramic precursor dispersion fully into the cavity of the mold. The remaining portion of the ceramic precursor dispersion that does not enter the cavity can be removed from the top surface of the mold and recycled. In some examples, a small portion of the ceramic precursor dispersion can remain on the top surface, and in other examples the top surface is substantially free of the dispersion. The pressure applied by the scraper or leveler bar can be less than 100 psi (0.6 MPa), or less than 50 psi (0.3 MPa), or even less than 10 psi (60 kPa). In some examples, no exposed surface of the ceramic precursor dispersion extends substantially beyond the top surface.

In those examples where it is desired to have the exposed surfaces of the cavities result in planar faces of the shaped ceramic abrasive particles, it can be desirable to overfill the cavities (e.g., using a micronozzle array) and slowly dry the ceramic precursor dispersion.

A further operation involves removing the volatile component to dry the dispersion. The volatile component can be removed by fast evaporation rates. In some examples, removal of the volatile component by evaporation occurs at temperatures above the boiling point of the volatile component. An upper limit to the drying temperature often depends on the material the mold is made from. For polypropylene tooling, the temperature should be less than the melting point of the plastic. In one example, for a water dispersion of between about 40 to 50 percent solids and a polypropylene mold, the drying temperatures can be between about 90° C. to about 165° C., or between about 105° C. to about 150° C., or between about 105° C. to about 120° C. Higher temperatures can lead to improved production speeds but can also lead to degradation of the polypropylene tooling, limiting its useful life as a mold.

During drying, the ceramic precursor dispersion shrinks, often causing retraction from the cavity walls. For example, if the cavities have planar walls, then the resulting formed ceramic abrasive particles can tend to have at least three concave major sides. It is presently discovered that by making the cavity walls concave (whereby the cavity volume is increased) it is possible to obtain formed ceramic abrasive particles that have at least three substantially planar major sides. The degree of concavity generally depends on the solids content of the ceramic precursor dispersion.

A further operation involves removing resultant precursor formed ceramic abrasive particles from the mold cavities. The precursor formed ceramic abrasive particles can be removed from the cavities by using the following processes alone or in combination on the mold: gravity, vibration, ultrasonic vibration, vacuum, or pressurized air to remove the particles from the mold cavities.

The precursor formed ceramic abrasive particles can be further dried outside of the mold. If the ceramic precursor dispersion is dried to the desired level in the mold, this additional drying step is not necessary. However, in some instances it can be economical to employ this additional drying step to minimize the time that the ceramic precursor dispersion resides in the mold. The precursor formed ceramic abrasive particles will be dried from 10 to 480 minutes, or from 120 to 400 minutes, at a temperature from 50° C. to 160° C., or 120° C. to 150° C.

A further operation involves calcining the precursor formed ceramic abrasive particles. During calcining, essentially all the volatile material is removed, and the various components that were present in the ceramic precursor dispersion are transformed into metal oxides. The precursor formed ceramic abrasive particles are generally heated to a temperature from 400° C. to 800° C., and maintained within this temperature range until the free water and over 90 percent by weight of any bound volatile material are removed. In an optional step, it can be desirable to introduce the modifying additive by an impregnation process. A water-soluble salt can be introduced by impregnation into the pores of the calcined, precursor formed ceramic abrasive particles. Then the precursor formed ceramic abrasive particles are pre-fired again.

A further operation can involve sintering the calcined, precursor formed ceramic abrasive particles to form ceramic particles. In some examples where the ceramic precursor includes rare earth metals, however, sintering may not be necessary. Prior to sintering, the calcined, precursor formed ceramic abrasive particles are not completely densified and thus lack the desired hardness to be used as formed ceramic abrasive particles. Sintering takes place by heating the calcined, precursor formed ceramic abrasive particles to a temperature of from 1000° C. to 1650° C. The length of time for which the calcined, precursor formed ceramic abrasive particles can be exposed to the sintering temperature to achieve this level of conversion depends upon various factors, but from five seconds to 48 hours is possible.

Whether calcined or not, the precursor formed ceramic abrasive particles (or calcined precursor formed ceramic abrasive particles) may be sintered. Prior to sintering, the (optionally calcined) precursor formed ceramic abrasive particles are not completely densified and thus lack the desired hardness to be used as formed ceramic abrasive particles. Sintering can take place by heating the (optionally calcined) precursor formed ceramic abrasive particles to a temperature of from 1000° C. to 1650° C. The heating time required to achieve densification depends upon various factors, but times of from five seconds to 48 hours are acceptable. Additional details on this method can be found in U.S. Published Patent Application No. 2015/0267097 (Rosenflanz).

In another embodiment, the duration of the sintering step ranges from one minute to 90 minutes. After sintering, the formed ceramic abrasive particles can have a Vickers hardness of 10 GPa (gigaPascals), 16 GPa, 18 GPa, 20 GPa, or greater.

Additional operations can be used to modify the described process, such as, for example, rapidly heating the material from the calcining temperature to the sintering temperature, and centrifuging the ceramic precursor dispersion to remove sludge and/or waste. Moreover, the process can be modified by combining two or more of the process steps if desired.

### EXAMPLES

Various embodiments of the present disclosure can be better understood by reference to the following Examples which are offered by way of illustration. The present disclosure is not limited to the Examples given herein.

### Materials

Unless stated otherwise, all reagents were obtained or are available from chemical vendors such as Sigma-Aldrich Company, St. Louis, Mo., or may be synthesized by known methods. Unless otherwise reported, all ratios are by dry weight.

Abbreviations for materials and reagents used in the examples are as follows:

| | |
|---|---|
| ACR | Trimethylolpropane triacrylate obtained under the trade designation “TMPTA” |
| | from Allnex Inc., Brussels, Belgium. |
| EP1 | Biphenol-A epoxy resin having an epoxy equivalent weight of 210-220 g/eq, |
| | obtained under the trade designation “EPONEX 1510” from Momentive |
| | Specialty Chemicals, Inc. |
| BYK W985: | Solution of acidic polyester with sodium o-phenylphenate, obtained under the |
| | trade designation “BYK-W 985” from Altana AG, Wesel, Germany. |
| Minex 10: | Anhydrous sodium potassium alumino silicate obtained from Unimin |
| | Corporation, New Canaan, Connecticut. |
| P400 | Aluminum oxide conforming the FEPA (Federation of the European Producers |
| | of Abrasives) standard for P400, obtained under the trade designation “BFRPL” |
| | from Imerys Fused Minerals, Niagara Falls, New York. |
| P180 | Alumina oxide, obtained under the trade designation ALODUR BFRPL, from |
| | Imery Fused Minerals GmbH, Billach, Austria. |
| PC1 | Mixture of 4-thiophenylphenyl diphenyl sulfonium hexafluoroantimonate, and |
| | bis[4-(diphenylsulfonio)phenyl]sulfide bis(hexafluoroantimonate) in propylene |
| | carbonate, obtained under the trade designation “CPI 6976” from Aceto |
| | Corporation, Port Washington, New York. |
| PC2 | Mixture of 4-thiophenylphenyl diphenyl sulfonium hexafluoroantimonate, and |
| | bis[4-(diphenylsulfonio)phenyl]sulfide bis(hexafluoroantimonate) in propylene |
| | carbonate, obtained under the trade designation “CPI 6976” from Aceto |
| | Corporation, Port Washington, New York. |
| IRG | 2-hydroxy-2-methyl-1-phenyl-1-propan-1-one obtained under trade designation |
| | “IRGACURE 1173” from BASF Corporation. |
| PP | Purple pigment commercially available under the trade designation “9S93” |
| | from Penn Color, Doylestown, Pennsylvania. |
| Devoflo 40CM | Calcium stearate dispersion available from EChem. |
| JC LMV7051 | Styrene acrylic emulsion available under the trade designation “Joncryl LMV |
| | 7051” from BASF Corporation. |
| HL 27 | Non-silicone antifoam from HARCROS |
| DOWICIL QK- | Broad-spectrum biocide available under the trade designation “DOWICIL |
| 20 | Antimicrobials” from DOW. |
| KATHON CG- | Biocide available under the trade designation “KATHON CG/ICP” from DOW. |
| ICP | |
| SAP1, SAP2, | Shaped abrasive particles prepared according to the description disclosed below |
| SAP3, SAP4, | in “Formation of Shaped Abrasive Particles”. |
| SAP5, SAP6, | |
| SAP7, SAP7a-e, | |
| SAP8, SAP9 | |

### Formation of Shaped Abrasive Particles

### Formation of SAP1

A sample of boehmite sol-gel was made using the following recipe: aluminum oxide monohydrate powder (800 parts) having the trade designation “DISPERAL” (Sasol, North America) was dispersed by high shear mixing a solution containing water (1100 parts) and 70% aqueous nitric acid (72 parts) and a suspension of goethite (α-FeOOH) as an iron oxide source (100 parts) for 11 minutes. The goethite suspension was synthesized by aging a dispersion of ferric hydroxide at elevated temperature and high pH. Additional information on the preparation of iron oxides has been previously disclosed and details can be found on EP 0 833 803 B1.

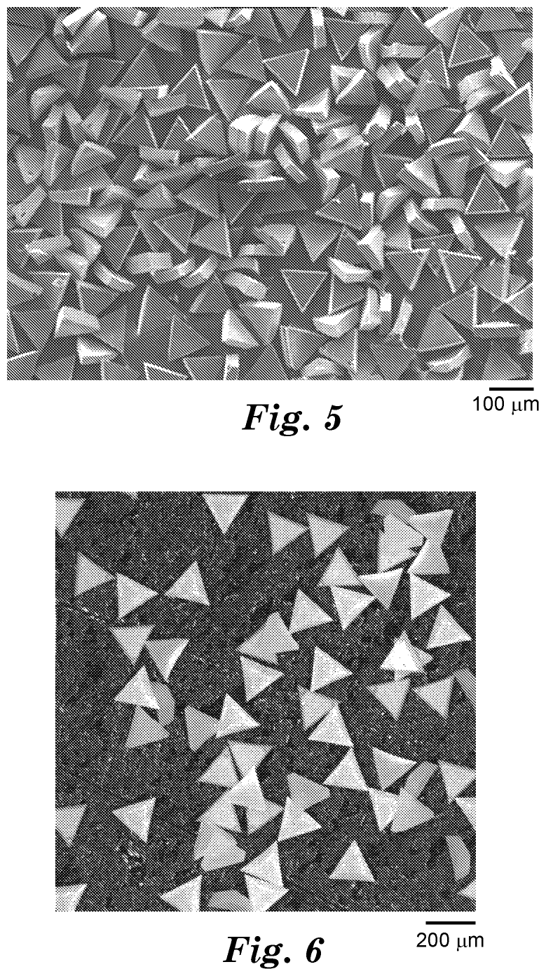

The resulting sol-gel was aged for at least 1 hour before coating. The sol-gel was forced into production tooling having triangular shaped mold cavities of 2.67 mils (69 microns) depth and 8 mils (203 microns) on each side. The draft angle α between the sidewall and bottom of the mold was 98 degrees. The sol-gel was forced into the cavities with a putty knife so that the openings of the production tooling were completely filled. A mold release agent, 0.2% peanut oil in methanol was used to coat the production tooling using a brush to fill the open cavities in the production tooling. The excess methanol was allowed to evaporate in a hood at room temperature. The sol-gel coated production tooling was allowed to air dry at room temperature for at least 10 minutes, giving a concentration of release agent (after evaporation of the methanol) of 0.08 mg/in^{t}, and an average thickness of the coating (prior to evaporation of the methanol) of 138 microns. The precursor shaped abrasive particles were removed from the production tooling by passing it over an ultrasonic horn. The precursor shaped abrasive particles were calcined at approximately 650° C. in a rotary tube kiln. Then, the particles were sintered at approximately 1200° C. in a box kiln. The fired shaped abrasive particles (with photomicrographs thereof shown in FIG. 5 were about 0.12 millimeter (side length)×0.025 millimeter thick. The average radius of curvature of the shaped abrasive particles was determined as the average radius of curvature of the open face tips of the particles. The radius of curvature was determined as the radius of the smallest circle that, when viewed in a direction orthogonal to the open face of the shaped abrasive particle including the open face tip, passes through a point on each of the two sides of the open face of the shaped abrasive particle that come together to form the tip at the start of a curve of the tip where each of the two sides transition from straight to curved. The average of 12 radii from four particles is taken.

### Formation of SAP2

A sample of boehmite sol-gel was made using the following recipe: aluminum oxide monohydrate powder (800 parts) having the trade designation “DISPERAL” (obtained Sasol North America Inc., Houston, Tex.) was dispersed by high shear mixing a solution containing water (1200 parts) and 70% aqueous nitric acid (72 parts) for 11 minutes. The resulting sol-gel was aged for at least 1 hour before coating. The sol-gel was forced into production tooling having triangular shaped mold cavities of 2.67 mils (69 microns) depth and 8 mils (203 microns) on each side. The draft angle α between the sidewall and bottom of the mold was 98 degrees. The sol-gel was forced into the cavities with a putty knife so that the openings of the production tooling were completely filled. A mold release agent, 0.2% peanut oil in methanol was used to coat the production tooling using a brush to fill the open cavities in the production tooling. The excess methanol was allowed to evaporate in a hood at room temperature. The sol-gel coated production tooling was allowed to air dry at room temperature for at least 10 minutes, giving a concentration of release agent (after evaporation of the methanol) of 0.08 mg/in^{t}, and an average thickness of the coating (prior to evaporation of the methanol) of 138 microns. The precursor shaped abrasive particles were removed from the production tooling by passing it over an ultrasonic horn. The precursor shaped abrasive particles were calcined at approximately 650° C. and then saturated with a mixed nitrate solution of the following concentration (reported as oxides): 1.8% each of MgO, Y₂O₃, Nd₂O₃ and La₂O₃. The excess nitrate solution was removed and the saturated precursor shaped abrasive particles were allowed to dry after which the particles were again calcined at 650° C. and sintered at approximately 1400° C. Both the calcining and sintering was performed using rotary tube kilns.

The fired shaped abrasive particles were about 0.12 millimeter (side length)×0.025 millimeter thick. The average radius of curvature of the resultant shaped abrasive particles was 2.0 micron, as measured according to the radius of curvature general measurement method described in the example for the formation of SAP1.

### Formation of SAP3

The procedure generally described in “Formation of SAP1” was repeated, with the exception that the sol-gel was forced into production tooling having triangular shaped mold cavities of 3.94 mils (100 microns) depth and 8 mils (203 microns) on each side. The draft angle α between the sidewall and bottom of the mold was 98 degrees. The fired shaped abrasive particles were about 0.12 millimeter (side length)×0.04 millimeter thick. The average radius of curvature of the resultant shaped abrasive particles was 2.0 micron, as measured according to the radius of curvature general measurement method described in the example for the formation of SAP1.

### Formation of SAP4

The procedure generally described in “Formation of SAP2” was repeated, with the exception that the sol-gel was forced into production tooling having triangular shaped mold cavities of 3.94 mils (100 microns) depth and 8 mils (203 microns) on each side. The draft angle α between the sidewall and bottom of the mold was 98 degrees. The fired shaped abrasive particles were about 0.12 millimeter (side length)×0.04 millimeter thick. The average radius of curvature of the resultant shaped abrasive particles was 2.0 micron, as measured according to the radius of curvature general measurement method described in the example for the formation of SAP1.

### Formation of SAP5

A sample of boehmite sol-gel was made using the following recipe: aluminum oxide monohydrate powder (800 parts) having the trade designation “DISPERAL” ((obtained Sasol North America Inc., Houston, Tex.)) was dispersed by high shear mixing a solution containing water (1100 parts) and 70% aqueous nitric acid (72 parts) and a suspension of goethite (α-FeOOH) as an iron oxide source (100 parts) for 11 minutes. The goethite suspension was synthesized by aging a dispersion of ferric hydroxide at elevated temperature and high pH. Additional information on the preparation of iron oxides is described in European Patent Number EP 0 833 803 B1, the contents of which are hereby incorporated by reference.

The resulting sol-gel was aged for at least 1 hour before coating. The sol-gel was forced into production tooling having triangular shaped mold cavities of 2.67 mils (69 microns) depth and 8 mils (203 microns) on each side. The draft angle α between the sidewall and bottom of the mold was 98 degrees. The sol-gel was forced into the cavities with a putty knife so that the openings of the production tooling were completely filled. A mold release agent, 0.2% peanut oil in methanol was used to coat the production tooling using a brush to fill the open cavities in the production tooling. The excess methanol was allowed to evaporate in a hood at room temperature. The sol-gel coated production tooling was allowed to air dry at room temperature for at least 10 minutes, giving a concentration of release agent (after evaporation of the methanol) of 0.08 mg/in^{t}, and an average thickness of the coating (prior to evaporation of the methanol) of 138 microns. The precursor shaped abrasive particles were removed from the production tooling by passing it over an ultrasonic horn. The precursor shaped abrasive particles were calcined at approximately 650° C. and then saturated with a mixed nitrate solution of the following concentration (reported as oxides): 1.1% MgO. The excess nitrate solution was removed and the saturated precursor shaped abrasive particles with openings were allowed to dry after which the particles were again calcined at 650° C. in a rotary tube kiln and sintered at approximately 1200° C. in a box kiln. The fired shaped abrasive particles were about 0.12 millimeter (side length)×0.025 millimeter thick. The average radius of curvature of the resultant shaped abrasive particles was 2.0 micron, as measured according to the radius of curvature general measurement method described in the example for the formation of SAP1.

### Formation of SAP6

The procedure generally described in “Formation of SAP5” was repeated, with the exception that the sol-gel was forced into production tooling having triangular shaped mold cavities of 3.94 mils (100 microns) depth and 8 mils (203 microns) on each side. The draft angle α between the sidewall and bottom of the mold was 98 degrees. The fired shaped abrasive particles were about 0.12 millimeter (side length)×0.04 millimeter thick. The average radius of curvature of the resultant shaped abrasive particles was 2.0 micron, as measured according to the radius of curvature general measurement method described in the example for the formation of SAP1.

### Formation of SAP7a-7e

The procedure generally described in “Formation of SAP5” was repeated with the exception that for the examples 7a-7e the concentration of MgO solution used to saturate the calcined shaped abrasive particles varied as described in Table 1. The fired shaped abrasive particles were about 0.12 millimeter (side length)×0.025 millimeter thick. The average radius of curvature of the resultant shaped abrasive particles was 2.0 micron, as measured according to the radius of curvature general measurement method described in the example for the formation of SAP1.

TABLE 1
MgO Content of SAPs 7a-7e

| Shaped Abrasive Particles | Example | MgO Content (wt %) |
|---|---|---|
| SAP7a | Example 7a | 0% |
| SAP7b | Example 7b | 0.875% |
| SAP7c | Example 7c | 1.75% |
| SAP7d | Example 7d | 3.5% |
| SAP7e | Example 7e | 7% |

### Formation of SAP 8

A sample of alumina slurry was prepared using the following recipe: calcined alumina oxide powder (3805 parts) having the trade designation RG 4000, available from Almatis, Ludwigshafen Germany, was dispersed using a high-shear blade into a solution containing water (1086 parts), citric acid (8 parts), magnesium citrate tribasic (6 parts), and sodium carboxymethylcellulose (19 parts) for 20 minutes.

The resulting slurry was shaped following the procedure generally described in “Formation of SAP1” with the exception that the slurry was forced into production tooling having triangular shaped mold cavities of 3.33 mils (85 microns) depth and 10 mils (254 microns) on each side. The draft angle α between the sidewall and bottom of the mold was 98 degrees. The precursor shaped abrasive particles were fired in a box kiln (Rapid Temp Furnace from CM Inc.) in an alumina crucible using a heating rate of 3° C./min with a hold time of 90 minutes at a maximum temperature of 1515° C. The fired shaped abrasive particles were about 0.2 millimeters (side length)×0.05 millimeters thick. The average radius of curvature was 2.1 microns, as measured according to the radius of curvature general measurement method described in the example for the formation of SAP 1. Photographs of abrasive particles according to SAP8 are shown in FIG. 6.

### Formation of SAP 9

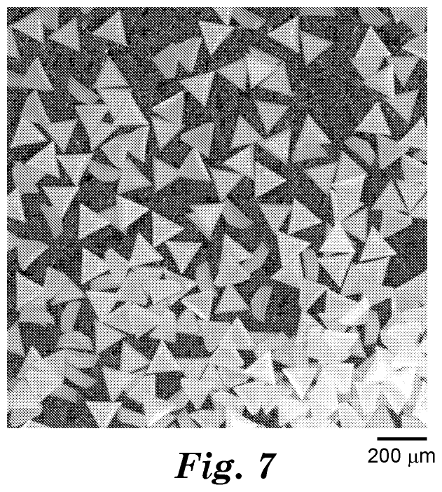

The procedure generally described in “Formation of SAP 8” was repeated, with the exception that the slurry was forced into production tooling having triangular shaped mold cavities of 2.67 mils (69 microns) depth and 8 mils (203 microns) on each side. The draft angle α between the sidewall and bottom of the mold was 98 degrees. The fired shaped abrasive particles were about 0.16 millimeters (side length)×0.04 millimeters thick. The average radius of curvature was 2.9 microns, as measured according to the radius of curvature general measurement method described in the example for the formation of SAP 1. Photographs of abrasive particles according to SAP9 are shown in FIG. 7.

### Preparation of Make Resin

A make resin was prepared, according to the composition listed in Table 2. The premix was prepared by mixing 70% EP1 and 30% ACR. To 55.40% of premix, 0.60% BYK-W-985, 40% Minex 10, 3% CPI 6976, and 1% Irgacure 1173. The formulation was stirred for 30 min. at room temperature until homogeneous.

TABLE 2
Make resin composition

| | Wt. % |
|---|---|
| Make Premix | |
| EP1 | 70.00% |
| ACR | 30.00% |
| | 100% |
| Liquid Make Resin | |
| Premix | 55.40% |
| Byk W985 | 0.60% |
| Minex 10 | 40.00% |
| CPI 6976 | 3.00% |
| Irgacure 819 | 1.00% |
| | 100% |

### Preparation of Size Resin

The size resin premix was prepared by mixing 70% EP3 and 30% ACR. To 55.06% of this premix, 0.59% W985, 39.95% Minex 10, 3% PC1, 1% IRG, and 0.40% PP was added. The formulation was stirred for 30 minutes at 24° C. until homogeneous.

### Preparation of Supersize Resin

The calcium stearate based supersize was prepared by mixing 74.7% calcium stearate dispersion (Devflo 40CM X), 12% styrene acrylic emulsion (JC LMV7051), 0.3% antifoaming agent (Antifoam HL27), 0.13% of DOWICIL QK-20 and 0.07% of KATHON CG-ICP as biocides in 12.8% water using high speed mixer. The formulation was stirred at 24° C. until homogeneous.

### Making Coated Abrasive Articles

### Example 1

Abrasive particle blend (prepared by mixing 10% shaped abrasive particles SAP1 and 90% P400) was coated onto the make resin (coating weight of 10 g/m²) at a nominal coating weight of 29 g/m² by electrostatic coating (Spellman SL 150). The coating was exposed to ultraviolet curing equipment (obtained from Fusion UV Systems, Gaithersburg, Md.) with one set of D bulbs operating at 600 Watts per inch (236 Watts per centimeter). The web is then exposed to thermal curing at a nominal web temperature setting of 140° C., for about 5 mins. The size resin was then roll coated onto the make layer and abrasive particles at a nominal dry coating weight of 29 g/m². The resultant article was exposed to ultraviolet curing equipment (obtained from Fusion UV Systems, Gaithersburg, Md.) with one set of D bulbs operating at 600 Watts per inch (236 Watts per centimeter). It was then processed through oven having a target temperature of 140° C. for 5 minutes. The resulting supersize composition was then applied over the cured size coated abrasive resin by means of a 3-roll mill, at a dry coating weight of 10 g/m², and dried for overnight at 21° C., then 5 mins at 90° C.

After drying, 3M 300LSE transfer adhesive was used to laminate film to a polyester based loop material. The two adhesive sides were pressed together, and air bubbles removed, using a manual roller. The resultant loop-backed abrasive coated resin was dried for overnight at 21° C., after which it was converted to 6-inch (15.24 cm) diameter discs as is known in the art. The resultant coated abrasive articles were then maintained at 24° C. and 40-60 percent relative humidity until tested.

### Example 2

A loop-backed abrasive coated resin was prepared as generally described in Example 1, where SAP2 was used instead of SAP1.

### Example 3

A loop-backed abrasive coated resin was prepared as generally described in Example 1, where SAP3 was used instead of SAP1.

### Example 4

A loop-backed abrasive coated resin was prepared as generally described in Example 1, where SAP4 was used instead of SAP1.

### Example 5

A loop-backed abrasive coated resin was prepared as generally described in Example 1, where SAP5 was used instead of SAP1.

### Example 6

A loop-backed abrasive coated resin was prepared as generally described in Example 1, where SAP6 was used instead of SAP1.

A loop-backed abrasive coated resin was prepared as generally described in Example 1, where SAP7a-7e was used according to Table 1, instead of SAP1.

### Example 8

Abrasive particle blend (prepared by mixing 10% shaped abrasive particles SAP8 and 90% P180) was coated onto the make resin (coating weight of 15 g/m²) at a nominal coating weight of 70 g/m² by electrostatic coating (Spellman SL 150). The coating was exposed to ultraviolet curing equipment (obtained from Fusion UV Systems, Gaithersburg, Md.) with one set of D bulbs operating at 600 Watts per inch (236 Watts per centimeter). The web is then exposed to thermal curing at a nominal web temperature setting of 140° C., for about 5 mins. The size resin was then roll coated onto the make layer and abrasive particles at a nominal dry coating weight of 65 g/m². The resultant article was exposed to ultraviolet curing equipment (obtained from Fusion UV Systems, Gaithersburg, Md.) with one set of D bulbs operating at 600 Watts per inch (236 Watts per centimeter). It was then processed through oven having a target temperature of 140° C. for 5 minutes. The resulting supersize composition was then applied over the cured size coated abrasive resin by means of a 3-roll mill, at a dry coating weight of 13 g/m², and dried for overnight at 21° C., then 5 mins at 90° C.

After drying, transfer adhesive available under the trade designation 300LSE, from 3M Company, St. Paul Minn. was used to laminate film to a polyester based loop material. The two adhesive sides were pressed together, and air bubbles removed, using a manual roller. The resultant loop-backed abrasive coated resin was dried for overnight at 21° C., after which it was converted to 6-inch (15.24 cm) diameter discs as is known in the art. The resultant coated abrasive articles were then maintained at 24° C. and 40-60 percent relative humidity until tested.

### Comparative Example A

5-inch loop-backed abrasive discs, obtained under the trade designation “Film Disc 375L P400”, from 3M Company, St. Paul, Minn., were employed as comparative examples.

### Comparative Example B

6-inch (15.24 cm) loop-backed abrasive discs, obtained under the trade designation “P400 334U”, from 3M Company, St. Paul, Minn., were employed as comparative examples. The discs have paper-based backing.

### Comparative Example C

6-inch (15.24 cm) obtained under trade designation 3M™ Hookit™ Purple+Abrasive Discs Multihole 734U P180 from 3M Company, St. Paul, Minn. were employed as comparative examples.

### CAB Sanding Tests (for Examples 1 & 2)

Abrasive performance testing was performed on a 15 inches by 21 inches CAB (Cellulose Acetate Butyrate) panel. Results are shown in Table 3. For testing purposes, the abrasive discs were attached to a 5-inch backup pad, commercially available under the trade designation “3M Hookit Low Profile Disc Pad 20352”, from 3M Company. Sanding was performed using a dual action axis of a servo controlled motor, disposed over an X-Y table, operating at 8,000 rpm, and 3/16-inch orbit. The abrasive article urged at an angle of 2.5 degrees against the panel at a load of 7 lbs. The tool was set to traverse in the Y direction along the length of the panel at the rate of 3.6 inches/second and in X direction at the rate of 3.6 inches/second along the width of the panel. Ten such passes along the length of the panel were completed in each cycle for a total of 8 cycles. The mass of the panel was measured before and after the first, seventh and eighth cycle to determine the mass loss from CAB panel in grams. Total cut, in grams, was determined as the cumulative mass loss at the end of the test. The total cut (%) was determined as the percent improvement of the example sample versus the comparative sample.

TABLE 3
CAB Sanding Tests

| | | Cycle | Cycle | Cycle | Total | Total |
|---|---|---|---|---|---|---|
| Samples | | 1 | 2-7 | 8 | Cut (g) | Cut (%) |
| Comparative A | Cut | 1.41 | 5.60 | 0.81 | 7.82 | 100 |
| CAB | (grams) | | | | | |
| Example 1 | Cut | 3.3 | 9.8 | 1.0 | 14.1 | 180 |
| CAB | (grams) | | | | | |
| Example 2 | Cut | 2.8 | 9.9 | 1.1 | 13.8 | 176 |
| CAB | (grams) | | | | | |

### Primer Sanding Tests (for Examples 1 & 2)

Abrasive performance testing was performed on 12 inches×18 inches×0.030 inches ACT Primer Test Panels. Results are shown in Tables 4 and 5. The ACT “Aged Primer” test panels are described as “ACT item number 59291 primer U28AW032A”. The ACT “New Primer” test panels are described as “ACT item number 60025 primer U28AW032B”. For testing purposes, the abrasive discs were attached to a 5-inch backup pad, commercially available under the trade designation “3M Hookit Low Profile Disc Pad 20352”, from 3M Company. Sanding was performed offhand using a random orbital sander operating at 12,000 rpm, and 3/16-inch orbit, commercially available under the trade designation “3M Random Orbital Sander 20325”, from 3M Company. The abrasive article was sanded flat by the operator in 30 second increments for a total of four cycles. The mass of the panel was measured before and after each cycle to determine the mass loss from the primer layer of the OEM panel in grams after each cycle. Total cut, in grams, was determined as the cumulative mass loss at the end of the test. The total cut (%) was determined as the percent improvement of the example sample versus the comparative sample.

TABLE 4
Aged Primer Sanding Tests.

| | | Cycle | Cycle | Cycle | Cycle | Total | Total |
|---|---|---|---|---|---|---|---|
| Samples | | 1 | 2 | 3 | 4 | Cut (g) | Cut (%) |
| Comparative A | Cut | 1.47 | 1.04 | 0.81 | 0.83 | 4.15 | 100 |
| “Aged Primer | (grams) | | | | | | |
| U28AW032A” | | | | | | | |
| Example 1 | Cut | 1.68 | 1.13 | 1.07 | 0.81 | 4.69 | 113 |
| “Aged Primer | (grams) | | | | | | |
| U28AW032A” | | | | | | | |
| Example 2 | Cut | 2.33 | 1.91 | 1.73 | 1.22 | 7.19 | 173 |
| “Aged Primer | (grams) | | | | | | |
| U28AW032A” | | | | | | | |

TABLE 5
New Primer Sanding Tests.

| | | Cycle | Cycle | Cycle | Cycle | Total | Total |
|---|---|---|---|---|---|---|---|
| Samples | | 1 | 2 | 3 | 4 | Cut (g) | Cut (%) |
| Comparative A | Cut | 0.54 | 0.30 | 0.25 | 0.25 | 1.34 | 100 |
| “New Primer | (grams) | | | | | | |
| U28AW032B” | | | | | | | |
| Example 1 | Cut | 0.80 | 0.70 | 0.30 | 0.30 | 2.1 | 157 |
| “New Primer | (grams) | | | | | | |
| U28AW032B” | | | | | | | |
| Example 2 | Cut | 0.90 | 0.84 | 0.66 | 0.50 | 0.34 | 216 |
| “New Primer | (grams) | | | | | | |
| U28AW032B” | | | | | | | |

### Solid Surface Sanding Tests (for Examples 1-6)

Abrasive performance testing was performed on a 14 inches by 14 inches Solid Surface (also known as Conan) panel. Results are shown in Table 6. For testing purposes, the abrasive discs were attached to a 5-inch backup pad, commercially available under the trade designation “3M Hookit Low Profile Disc Pad 20352”, from 3M Company. Sanding was performed using a dual action axis of a servo controlled motor, disposed over an X-Y table, operating at 8000 rpm, and 3/16-inch orbit. The abrasive article urged at an angle of 2.5 degrees against the panel at a load of 7.5 lbs. The tool was set to traverse in the Y direction along the length of the panel at the rate of 3.6 inches/second and in X direction at the rate of 3.6 inches/second along the width of the panel. Fifteen such passes along the length of the panel were completed in each cycle for a total of 4 cycles. The mass of the panel was measured before and after each cycle to determine the mass loss from the Solid Surface panel in grams. Total cut, in grams, was determined as the cumulative mass loss at the end of the test. The total cut (%) was determined as the percent improvement of the example sample versus the comparative sample.

TABLE 6
Solid Surface Sanding Tests.

| | | Cycle | Cycle | Cycle | Cycle | Total | Total |
|---|---|---|---|---|---|---|---|
| Samples | | 1 | 2 | 3 | 4 | Cut (g) | Cut (%) |
| Comparative A | Cut | 1.44 | 1.27 | 1.22 | 1.18 | 5.11 | 100 |
| Solid Surface | (grams) | | | | | | |
| Example 1 | Cut | 1.13 | 0.73 | 0.60 | 0.56 | 3.02 | 59 |
| Solid Surface | (grams) | | | | | | |
| Example 2 | Cut | 2.65 | 2.42 | 2.28 | 2.22 | 9.57 | 187 |
| Solid Surface | (grams) | | | | | | |
| Comparative A | Cut | 1.41 | 1.28 | 1.16 | 1.15 | 5.00 | 100 |
| Solid Surface | (grams) | | | | | | |
| Example 1 | Cut | 1.68 | 1.33 | 1.22 | 1.12 | 5.35 | 107 |
| Solid Surface | (grams) | | | | | | |
| Example 3 | Cut | 1.98 | 1.62 | 1.48 | 1.38 | 6.46 | 129 |
| Solid Surface | (grams) | | | | | | |
| Example 5 | Cut | 2.07 | 1.76 | 1.63 | 1.52 | 6.98 | 140 |
| Solid Surface | (grams) | | | | | | |
| Example 6 | Cut | 2.22 | 1.92 | 1.74 | 1.64 | 7.52 | 150 |
| Solid Surface | (grams) | | | | | | |
| Example 4 | Cut | 2.43 | 2.18 | 2.04 | 1.98 | 8.63 | 173 |
| Solid Surface | (grams) | | | | | | |

Sanding Tests (for Examples 7a-7e)

Abrasive performance testing was performed on an 18 inches by 24 inches (45.7 cm by 61 cm) painted with Axalta primer. Results are shown in Table 7. For testing purposes, the abrasive discs were attached to a 6-inch (15.2 cm) backup pad, commercially available under the trade designation “HOOKIT BACKUP PAD, PART NO. 05865”, from 3M Company with an interface pad. The tool was disposed over an X-Y table with 18 inches (45.7 cm)×24 inches (61.0 cm)×0.036 inches (0.09 cm) dimensions, secured to the X-Y table. Sanding was performed using a dual action axis of a servo controlled motor, disposed over an X-Y table, operating at 4500 rpm, and 3/16 inch (4.76 mm) stroke, and the abrasive article urged at an angle of 2.5 degrees against the panel at a load of 12 lbs. (5.44 Kg). After dulling the discs on steel at the rate of 2 inches/sec, the tool was then set to traverse in the Y direction along the length of the panel at the rate of 3 inches/second and in X direction at the rate of 3 inches/second along the width of the panel. Seven such passes along the length of the panel were completed in each cycle for a total of 6 cycles. The mass of the panel was measured before and after each cycle to determine the mass loss from the clear coating layer of OEM panel in grams after each cycle. Total cut was determined as the cumulative mass loss at the end of the test. Cut life was calculated by ratio of last minute cut divided by first minute cut for all samples.

TABLE 7
Sanding Tests

| | | Sanding Time (seconds) | | | | | | Total Cut | |
|---|---|---|---|---|---|---|---|---|---|
| Sample | | 60 | 120 | 180 | 240 | 300 | 360 | (grams) | Cut Life |
| Example 7a | Cut | 4.23 | 3.65 | 3.23 | 2.86 | 2.65 | 2.39 | 18.99 | 0.57 |
| | (grams) | | | | | | | | |
| Example 7b | Cut | 4.84 | 4.37 | 3.97 | 3.62 | 3.36 | 3.13 | 23.27 | 0.65 |
| | (grams) | | | | | | | | |
| Example 7c | Cut | 4.86 | 4.43 | 4.00 | 3.72 | 3.44 | 3.20 | 23.64 | 0.66 |
| | (grams) | | | | | | | | |
| Example 7d | Cut | 4.82 | 4.40 | 3.98 | 3.59 | 3.25 | 2.85 | 22.88 | 0.59 |
| | (grams) | | | | | | | | |
| Example 7e | Cut | 5.00 | 4.53 | 4.11 | 3.68 | 3.25 | 2.89 | 23.45 | 0.58 |
| | (grams) | | | | | | | | |
| Comparative B | Cut | 4.54 | 3.86 | 3.19 | 2.65 | 2.16 | 1.74 | 18.12 | 0.38 |
| | (grams) | | | | | | | | |

### Abrading Test Method for Example 8:

Abrasive performance testing was performed on an 18 inch by 24 inch (45.7 cm by 61 cm) black painted cold roll steel test panels having NEXA OEM type clearcoat, obtained from ACT Laboratories, Inc., Hillsdale, Mich. Results are shown in Table 8. For testing purposes, the abrasive discs were attached to a 6-inch (15.2 cm) backup pad, commercially available under the trade designation “HOOKIT BACKUP PAD, PART NO. 05865”, from 3M Company. Sanding was performed using a dual action axis of a servo-controlled motor, disposed over an X-Y table, operating at 6,700 rpm, and 3/16 inch (4.76 mm) stroke, and the abrasive article urged at an angle of 2.5 degrees against the panel at a load of 15 lbs (6.80 Kg). After dulling the discs on steel at the rate of 2 inches/sec, the tool was then set to traverse in the Y direction along the length of the panel at the rate of 3.50 inches/minute (8.9 cm/minute) and in X direction at the rate of 5 inches/minute (8.9 cm/minute) along the width of the panel. Seven such passes along the length of the panel were completed in each cycle for a total of 4 cycles. The mass of the panel was measured before and after each cycle to determine the mass loss from the clear coating layer of OEM panel in grams after each cycle. Total cut was determined as the cumulative mass loss at the end of the test.

TABLE 8
Sanding Tests

| | Sanding Time (seconds) | | | | Total cut | Total Cut |
|---|---|---|---|---|---|---|
| Sample | 60 | 120 | 180 | 240 | (grams) | (%) |
| Example 8 | 6.97 | 4.25 | 2.84 | 1.88 | 15.94 | 114 |
| Comparative C | 6.01 | 3.49 | 2.62 | 1.84 | 13.96 | 100 |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed can be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides a formed ceramic abrasive particle comprising:

a plurality of ceramic oxides;

at least one of a first plurality of oxides and a second plurality of oxides, the first plurality of oxides chosen from an oxide of yttrium, praseodymium, samarium, ytterbium, neodymium, lanthanum, gadolinium, dysprosium, erbium, and mixtures thereof, and the second plurality of oxides chosen from an oxide of iron, magnesium, zinc, silicon, cobalt, nickel, zirconium, hafnium, chromium, cerium, titanium, and mixtures thereof;

a plurality of edges, each edge having a length independently ranging from about 0.1 μm to about 5000 μm; and

a tip defined by a junction of at least two of the edges, the tip having a radius of curvature ranging from about 0.5 μm to about 80 μm.

Embodiment 2 provides the formed ceramic abrasive particle of Embodiment 1, wherein the ceramic oxides comprise fused aluminium oxide material, heat treated aluminium oxide material, sintered aluminium oxide material, silicon carbide material, titanium diboride, boron carbide, tungsten carbide, titanium carbide, cubic boron nitride, garnet, fused alumina-zirconia, cerium oxide, zirconium oxide, titanium oxide, or mixtures thereof.

Embodiment 3 provides the formed ceramic abrasive particle of Embodiment 1, wherein the ceramic oxides comprise alpha alumina.

Embodiment 4 provides the formed ceramic abrasive particle of any one of Embodiments 1-3, wherein the ceramic oxides range from about 5 wt % to about 99 wt % of the abrasive particle.

Embodiment 5 provides the formed ceramic abrasive particle of Embodiment 4, wherein the ceramic oxides range from about 95 wt % to about 99 wt % of the abrasive particle.

Embodiment 6 provides the formed ceramic abrasive particle of any one of Embodiments 1-5, wherein the first plurality of oxides ranges from about 0.01 wt % to about 70 wt % of the abrasive particle.

Embodiment 7 provides the formed ceramic abrasive particle of any one of Embodiments 1-6, wherein the first plurality of oxides ranges from about 1 wt % to about 30 wt % of the abrasive particle.

Embodiment 8 provides the formed ceramic abrasive particle of any one of Embodiments 1-7, wherein the second plurality of oxides ranges from about 0.01 wt % to about 15 wt % of the abrasive particle.

Embodiment 9 provides the formed ceramic abrasive particle of any one of Embodiments 1-8, wherein the second plurality of oxides ranges from about 0.5 wt % to about 3 wt % of the abrasive particle.

Embodiment 10 provides the formed ceramic abrasive particle of any one of Embodiments 1-9, wherein the second plurality of oxides comprises an oxide of magnesium.

Embodiment 11 provides the formed ceramic abrasive particle of Embodiment 10, wherein the oxide of magnesium is MgO.

Embodiment 12 provides the formed ceramic abrasive particle of 11, wherein the MgO ranges from about 0.1 wt % to about 10 wt % of the abrasive particle.

Embodiment 13 provides the formed ceramic abrasive particle of any one of Embodiments 11-12, wherein the MgO ranges from about 0.7 wt % to about 2 wt % of the abrasive particle.

Embodiment 14 provides the formed ceramic abrasive particle of any one of Embodiments 1-13, wherein the second plurality of oxides comprises an oxide of iron.

Embodiment 15 provides the formed ceramic abrasive particle of Embodiment 14, wherein the oxide of iron is chosen from FeO, Fe₂O₃, Fe₃O₄, Fe₄O₅, and mixtures thereof.

Embodiment 16 provides the formed ceramic abrasive particle of any one of Embodiments 14 or 15, wherein the oxide of iron is Fe₂O₃.

Embodiment 17 provides the formed ceramic abrasive particle of any one of Embodiments 14-16, wherein the oxide of iron ranges from about 0.01 wt % to about 10 wt % of the abrasive particle.

Embodiment 18 provides the formed ceramic abrasive particle of any one of Embodiments 1-17, wherein the second plurality of oxides comprises MgO and Fe₂O₃.

Embodiment 19 provides the formed ceramic abrasive particle of any one of Embodiments 1-18, wherein a porosity of the abrasive particle ranges from about 0.01% to about 5%.

Embodiment 20 provides the formed ceramic abrasive particle of any one of Embodiments 1-19, wherein a porosity of the abrasive particle ranges from about 0.01% to about 2%.

Embodiment 21 provides the formed ceramic abrasive particle of any one of Embodiments 1-20, wherein a length of individual ceramic oxides independently ranges from about 0.05 μm to about 1 μm.

Embodiment 22 provides the formed ceramic abrasive particle of any one of Embodiments 1-21, wherein a length of the individual ceramic oxides independently ranges from about 0.1 μm to about 0.7 μm.

Embodiment 23 provides the formed ceramic abrasive particle of any one of Embodiments 1-22, wherein at least one of the ceramic oxides, the first plurality of oxides, and the second plurality of oxides are homogenously distributed throughout the abrasive particle.

Embodiment 24 provides the formed ceramic abrasive particle of any one of Embodiments 1-23, wherein the body of the formed ceramic abrasive particle is tetrahedral and comprises four faces joined by six edges terminating at four tips, each one of the four faces contacting three of the four faces.

Embodiment 25 provides the formed ceramic abrasive particle of Embodiment 24, wherein at least one of the four faces is substantially planar.

Embodiment 26 provides the formed ceramic abrasive particle of any one of Embodiments 24 or 25, wherein at least one of the four faces is concave.

Embodiment 27 provides the formed ceramic abrasive particle of Embodiment 24, wherein all of the four faces are concave.

Embodiment 28 provides the formed ceramic abrasive particle of Embodiment 24, wherein at least one of the four faces is convex.

Embodiment 29 provides the formed ceramic abrasive particle of Embodiment 24, wherein all of the four faces are convex.

Embodiment 30 provides the formed ceramic abrasive particle of Embodiments 24-29, wherein at least one of the tetrahedral abrasive particles has equally sized edges.

Embodiment 31 provides the formed ceramic abrasive particle of Embodiments 24-30, wherein at least one of the tetrahedral abrasive particles has different-sized edges.

Embodiment 32 provides the formed ceramic abrasive particle of any one of Embodiments 1-31, wherein the body comprises a first side and a second side separated by a thickness t, the first side comprises a first face having a triangular perimeter and the second side comprises a second face having a triangular perimeter, wherein the thickness t is equal to or smaller than the length of the shortest side-related dimension of the particle.

Embodiment 33 provides the formed ceramic abrasive particle of Embodiment 32, further comprising at least one sidewall connecting the first side and the second side.

Embodiment 34 provides the formed ceramic abrasive particle of Embodiment 33, wherein the at least one sidewall is a sloping sidewall.

Embodiment 35 provides the formed ceramic abrasive particle according to any one of Embodiments 33-34, wherein the first face and the second face are substantially parallel to each other.

Embodiment 36 provides the formed ceramic abrasive particle according to any one of Embodiments 33-35, wherein the first face and the second face are substantially non-parallel to each other.

Embodiment 37 provides the formed ceramic abrasive particle according to any one of Embodiments 33-36, wherein at least one of the first and the second face are substantially planar.

Embodiment 38 provides the formed ceramic abrasive particle according to any one of Embodiments 33-37, wherein at least one of the first and the second face is a non-planar face.

Embodiment 39 provides a method of making the formed ceramic abrasive particle according to any one of Embodiments 1-38, the method comprising:

molding a dispersion comprising ceramic particles or a precursor thereof, at least one of the first plurality of oxides, the second plurality of oxides, or mixtures thereof;

drying the molded dispersion to form a solid; and

calcining the solid to form a particle.

Embodiment 40 provides the method of Embodiment 39, further comprising seeding the dispersion with an oxide of iron.

Embodiment 41 provides the method according to any one of Embodiments 39 or 40, further comprising adding an oxide of magnesium to the solid.

Embodiment 42 provides the method of Embodiment 41, wherein the oxide of magnesium is added to the solid after calcining the particle.

Embodiment 43 provides the method according to any one of Embodiments 39-41, further comprising sintering the particle.

Embodiment 44 provides a coated abrasive article comprising:

a backing defining a surface along an x-y direction; and

an abrasive layer comprising the formed ceramic abrasive particle according to any one of Embodiments 1-38 or formed according to the method of any one of Embodiments 39-43 attached to the backing by a make coat.

Embodiment 45 provides the coated abrasive article of Embodiment 44, wherein the backing is a flexible backing.

Embodiment 46 provides the coated abrasive article of any one of Embodiments 44 or 45, wherein the backing comprises at least one material chosen from a polymeric film, a metal foil, a woven fabric, a knitted fabric, paper, vulcanized fiber, a staple fiber, a continuous fiber, a nonwoven, a foam, a screen, and a laminate.

Embodiment 47 provides the coated abrasive article of any one of Embodiments 44-46, wherein the make coat comprises a resinous adhesive.

Embodiment 48 provides the coated abrasive article of Embodiment 47, wherein the resinous adhesive comprises one or more resins.

Embodiment 49 provides the coated abrasive article of Embodiment 48, wherein the one or more resins are chosen from a phenolic resin, an epoxy resin, a urea-formaldehyde resin, an acrylate resin, an aminoplast resin, a melamine resin, an acrylated epoxy resin, a urethane resin, and mixtures thereof.

Embodiment 50 provides a bonded abrasive article comprising:

a first major surface and an opposed second major surface each contacting a peripheral side surface;

a central axis extending through the first and second major surfaces;

a layer comprising the formed ceramic abrasive particle according to any one of Embodiments 1-38 or formed according to the method of any one of Embodiments 39-49; and

a binder material retaining the layer comprising the formed ceramic abrasive particle.

Embodiment 51 provides the bonded abrasive article of Embodiment 50, wherein the first major surface and the second major surface have a substantially circular profile.

Embodiment 52 provides the bonded abrasive article according to any one of Embodiments 50 or 51, further comprising a central aperture extending between the first and second major surfaces.

Embodiment 53 provides the bonded abrasive article of Embodiment 52, wherein the central axis extends through the aperture.

Embodiment 54 provides the bonded abrasive article according to any one of Embodiments 50-53, wherein the formed ceramic abrasive particle of the layer is encapsulated by the binder material.

Embodiment 55 provides the bonded abrasive article according to any one of Embodiments 50-54, wherein the binder material comprises an organic binder.

Embodiment 56 provides the bonded abrasive article according to any one of Embodiments 50-55, wherein the binder material comprises a vitrified binder material.

Embodiment 57 provides the bonded abrasive article according to any one of Embodiments 50-56, wherein the binder material comprises a metallic binder material.

Embodiment 58 provides the coated abrasive article according to any one of Embodiments 44-49 or the bonded abrasive article of any one of Embodiments 50-57, wherein the abrasive article is at least one of a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a double disk grinding wheel, a belt, or a portion thereof.

Embodiment 59 provides an abrasive article comprising the formed ceramic abrasive particle of any one of Embodiments 1-38 or formed according to any one of Embodiments 39-43.

Embodiment 60 provides the abrasive article of Embodiment 59, wherein the abrasive particle is chosen from a non-woven abrasive article, a structured abrasive article, a coated abrasive article, and a bonded abrasive article.

Embodiment 61 provides a method of using the coated abrasive article according to any one of Embodiments 44-49 or the bonded abrasive article according to any one of 50-58, or the abrasive article of any one of Embodiments 59 or 60, the method comprising:

contacting the coated abrasive article or the bonded abrasive article with a substrate; and

moving at least one of the coated abrasive article or bonded abrasive article relative to the substrate and the substrate relative to the coated abrasive article or bonded abrasive article.

Embodiment 62 provides the method of Embodiment 61, wherein the movement of at least one of the coated abrasive article, bonded abrasive article, and substrate is lateral or rotational.

Embodiment 63 provides the method according to any one of Embodiments 61 or 62, wherein the substrate is chosen from paint, primer, a plastic, and combinations thereof.

1. A formed ceramic abrasive particle comprising:
a plurality of ceramic oxides;
a first plurality of oxides, a second plurality of oxides, or a mixture thereof, wherein
the first plurality of oxides comprise an oxide of yttrium, praseodymium, samarium, ytterbium, neodymium, lanthanum, gadolinium, dysprosium, erbium, or a combination thereof, and
the second plurality of oxides comprise an oxide of iron, magnesium, zinc, silicon, cobalt, nickel, zirconium, hafnium, chromium, cerium, titanium, or a combination thereof;
a plurality of edges, each edge having a length independently ranging from about 0.1 μm to about 5000 μm; and
a tip defined by a junction of at least two of the edges, the tip having a radius of curvature ranging from about 0.5 μm to about 80 μm.

2. The formed ceramic abrasive particle of claim 1, wherein the ceramic oxides independently comprise fused aluminium oxide material, heat treated aluminium oxide material, sintered aluminium oxide material, silicon carbide material, titanium diboride, boron carbide, tungsten carbide, titanium carbide, cubic boron nitride, garnet, fused alumina-zirconia, cerium oxide, zirconium oxide, titanium oxide, or mixtures thereof.

3. The formed ceramic abrasive particle of claim 1, wherein the first plurality of oxides ranges from about 0.01 wt % to about 70 wt % of the abrasive particle.

4. The formed ceramic abrasive particle of claim 1, wherein the second plurality of oxides ranges from about 0.01 wt % to about 15 wt % of the abrasive particle.

5. The formed ceramic abrasive particle of claim 1, wherein the second plurality of oxides comprises an oxide of magnesium.

6. The formed ceramic abrasive particle of 5, wherein the oxide of magnesium ranges from about 0.1 wt % to about 10 wt % of the abrasive particle.

7. The formed ceramic abrasive particle of claim 1, wherein the second plurality of oxides comprises an oxide of iron.

8. The formed ceramic abrasive particle of claim 1, wherein the second plurality of oxides comprises MgO and Fe₂O₃.

9. The formed ceramic abrasive particle of claim 1, wherein a length of individual ceramic oxides independently ranges from about 0.05 μm to about 1 μm.

10. The formed ceramic abrasive particle of claim 1, wherein the body of the formed ceramic abrasive particle is tetrahedral and comprises four faces joined by six edges terminating at four tips, each one of the four faces contacting three of the four faces.

11. A method of making a formed ceramic abrasive particle, the method comprising:
molding a dispersion comprising ceramic particles or a precursor thereof, a first plurality of oxides, a second plurality of oxides, or mixtures thereof, wherein
the first plurality of oxides comprise an oxide of yttrium, praseodymium, samarium, ytterbium, neodymium, lanthanum, gadolinium, dysprosium, erbium, or a combination thereof, and
the second plurality of oxides comprise an oxide of iron, magnesium, zinc, silicon, cobalt, nickel, zirconium, hafnium, chromium, cerium, titanium, or a combination thereof;
drying the molded dispersion to form a solid; and
calcining the solid to form a particle.

12. The method of claim 11, further comprising seeding the dispersion with an oxide of iron.

13. The method according to claim 11, further comprising adding an oxide of magnesium to the solid.

14. The method of claim 13, wherein the oxide of magnesium is added to the solid after calcining the particle.

15. The method according to any claim 11, further comprising sintering the particle.

16. An abrasive article comprising a plurality of ceramic oxides, the ceramic oxides independently comprising:
a first plurality of oxides, a second plurality of oxides, or a mixture thereof, wherein
the first plurality of oxides comprise an oxide of yttrium, praseodymium, samarium, ytterbium, neodymium, lanthanum, gadolinium, dysprosium, erbium, or a combination thereof, and
the second plurality of oxides comprise an oxide of iron, magnesium, zinc, silicon, cobalt, nickel, zirconium, hafnium, chromium, cerium, titanium, or a combination thereof;
a plurality of edges, each edge having a length independently ranging from about 0.1 μm to about 5000 μm, and
a tip defined by a junction of at least two of the edges, the tip having a radius of curvature ranging from about 0.5 μm to about 80 μm.

17. The abrasive article of claim 16, wherein the abrasive particle is chosen from a non-woven abrasive article, a structured abrasive article, a coated abrasive article, and a bonded abrasive article.

18. A method of using the abrasive article according to claim 16, the method comprising:
contacting the abrasive article with a substrate; and
moving at least one of the abrasive article relative to the substrate and the substrate relative to the abrasive article.

19. The method of claim 18, wherein the movement of the abrasive article, and substrate is lateral or rotational.

20. The method according to claim 18, wherein the substrate is chosen from paint, primer, a plastic, and combinations thereof.
